(19) United States
(12) Patent Application Publication
(10) Pub. No.: US 2024/0356679 A1
(43) Pub. Date: Oct. 24, 2024

(54) GROUPCAST RETRANSMISSION TECHNIQUES

(71) Applicant: QUALCOMM Incorporated, San Diego, CA (US)

(72) Inventors: Zhichao ZHOU, Beijing (CN); Seyedkianoush HOSSEINI, San Diego, CA (US); Chih-Ping LI, San Diego, CA (US); Amira ALLOUM, Boulogne Billancourt (FR); Mickael MONDET, Louannec (FR); Hui GUO, Beijing (CN)

(21) Appl. No.: 18/701,142

(22) PCT Filed: Dec. 21, 2021
(86) PCT No.: PCT/CN2021/140027

§ 371 Date: Apr. 12, 2024

(51) Int. Cl. H04L 1/1812; H04L 1/1829

(52) U.S. Cl. CPC H04L 1/1816; H04L 1/1848

(57) ABSTRACT

Methods, systems, and devices for wireless communications are described. A user equipment (UE) of a group of UEs may receive a groupcast retransmission from one or more UEs of the group. For example, a base station may transmit a groupcast transmission to the group of UEs. A first UE of the group of UEs may fail to receive the groupcast transmission and, in response, may transmit a feedback message via a sidelink feedback resource to a second UE of the group of UEs. The feedback message may include a negative acknowledgement (NACK) that indicates the failed reception of the groupcast transmission by the first UE, and the sidelink feedback resource may be indicated by the base station. The second UE may transmit a retransmission of the groupcast transmission to the first UE via a sidelink resource based on receiving the feedback message.

### CROSS REFERENCE

The present Application is a 371 national stage filing of International PCT Application No. PCT/CN2021/140027 by ZHOU et al. entitled “GROUPCAST RETRANSMISSION TECHNIQUES,” filed Dec. 21, 2021, which is assigned to the assignee hereof, and which is expressly incorporated by reference in its entirety herein.

### FIELD OF TECHNOLOGY

The following relates to wireless communications, including groupcast retransmission techniques.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In some wireless communications systems, a base station may transmit a groupcast transmission to a group of UEs over an access link. In some cases, a UE of the group of UEs may fail to receive or decode the groupcast transmission and may transmit a negative acknowledgement (NACK) to the base station to indicate the failed reception. In response, the base station may retransmit the groupcast transmission to the UE over the access link, which, in some cases, may increase resource usage and congestion of the access link.

### SUMMARY

The described techniques relate to improved methods, systems, devices, and apparatuses that support groupcast retransmission techniques. Generally, the described techniques provide for enabling the retransmission of groupcast transmissions via sidelink resources. For example, a base station may transmit a groupcast transmission to a group of user equipments (UEs), and a first UE of the group of UEs may fail to receive or decode the groupcast transmission. In response, the first UE may transmit a first feedback message that includes a negative acknowledgement (NACK) to a second UE of the group of UEs via a first sidelink feedback resource (e.g., indicated by the base station). The NACK may indicate to the second UE that first UE failed to receive or decode the groupcast transmission. The second UE may successfully receive and decode the groupcast transmission from the base station. Accordingly, in response to receiving the first feedback message the includes the NACK, the second UE may transmit, using a sidelink resource (e.g., of a physical sidelink shared channel (PSSCH)), a retransmission of the groupcast transmission to the first UE.

The first UE may monitor the sidelink resource for the groupcast retransmission and, if the first UE successfully receives the groupcast retransmission, the first UE may transmit a second feedback message that includes an acknowledgement (ACK) to the base station via an uplink resource and to the second UE (e.g., and the group of UEs) via a second sidelink feedback resource, where the ACK indicates a successful reception of the groupcast retransmission. Alternatively, if the first UE fails to receive and decode the groupcast retransmission, the first UE may transmit a second feedback message including a second NACK to the base station, the second UE, or both. In some examples, the second UE may transmit a second retransmission of the groupcast transmission to the first UE in response to receiving the second feedback message. In some examples, the base station may retransmit the groupcast transmission to the first UE, for example, in response to receiving the second feedback message or not receiving the ACK from the first UE within some period of time after transmitting the groupcast transmission.

A method for wireless communication at a first UE is described. The method may include monitoring, from a base station via a communication link, for a groupcast transmission associated with a group of UEs including the first UE, transmitting, to a second UE of the group of UEs and via a sidelink feedback resource, a feedback message including a NACK that indicates a failed reception of the groupcast transmission by the first UE, and monitoring, from the second UE via a sidelink resource, for a retransmission of the groupcast transmission based on transmitting the feedback message including the NACK.

An apparatus for wireless communication at a first UE is described. The apparatus may include a processor, memory coupled with the processor, and instructions stored in the memory. The instructions may be executable by the processor to cause the apparatus to monitor, from a base station via a communication link, for a groupcast transmission associated with a group of UEs including the first UE, transmit, to a second UE of the group of UEs and via a sidelink feedback resource, a feedback message including a NACK that indicates a failed reception of the groupcast transmission by the first UE, and monitor, from the second UE via a sidelink resource, for a retransmission of the groupcast transmission based on transmitting the feedback message including the NACK.

Another apparatus for wireless communication at a first UE is described. The apparatus may include means for monitoring, from a base station via a communication link, for a groupcast transmission associated with a group of UEs including the first UE, means for transmitting, to a second UE of the group of UEs and via a sidelink feedback resource, a feedback message including a NACK that indicates a failed reception of the groupcast transmission by the first UE, and means for monitoring, from the second UE via a sidelink resource, for a retransmission of the groupcast transmission based on transmitting the feedback message including the NACK.

A non-transitory computer-readable medium storing code for wireless communication at a first UE is described. The code may include instructions executable by a processor to monitor, from a base station via a communication link, for a groupcast transmission associated with a group of UEs including the first UE, transmit, to a second UE of the group of UEs and via a sidelink feedback resource, a feedback message including a NACK that indicates a failed reception of the groupcast transmission by the first UE, and monitor, from the second UE via a sidelink resource, for a retransmission of the groupcast transmission based on transmitting the feedback message including the NACK.

Some examples of the method, apparatuses, and non-transitory computer-readable medium described herein may further include operations, features, means, or instructions for receiving, from the second UE via the sidelink resource, the retransmission of the groupcast transmission via the sidelink resource based on the monitoring and transmitting, to at least one of the second UE via a second sidelink feedback resource or the base station via the communication link, a second feedback message including an ACK that indicates successful reception of the retransmission of the groupcast transmission by the first UE.

Some examples of the method, apparatuses, and non-transitory computer-readable medium described herein may further include operations, features, means, or instructions for receiving, from the base station via the communication link, a message that indicates the sidelink feedback resource for the first UE to use to transmit the feedback message including the NACK.

In some examples of the method, apparatuses, and non-transitory computer-readable medium described herein, the message may be received in downlink control information (DCI) or radio resource control (RRC) signaling.

Some examples of the method, apparatuses, and non-transitory computer-readable medium described herein may further include operations, features, means, or instructions for receiving, from the base station via the communication link, a message that indicates the sidelink resource for the first UE to use to receive the retransmission of the groupcast transmission, where the sidelink resource may be monitored by the first UE based on receiving the message that indicates the sidelink resource.

In some examples of the method, apparatuses, and non-transitory computer-readable medium described herein, the sidelink resource to monitor for the retransmission of the groupcast transmission may be based on a mapping that maps the sidelink feedback resource to the sidelink resource.

Some examples of the method, apparatuses, and non-transitory computer-readable medium described herein may further include operations, features, means, or instructions for receive, from the second UE and based on transmitting the feedback message including the NACK, sidelink control information (SCI) that reserves the sidelink resource for the retransmission of the groupcast transmission, where the sidelink resource may be monitored by the first UE based on receiving the SCI.

Some examples of the method, apparatuses, and non-transitory computer-readable medium described herein may further include operations, features, means, or instructions for receiving, from the base station via the communication link, the retransmission of the groupcast transmission based on failing to successfully receive or decode the retransmission of the groupcast transmission from the second UE.

Some examples of the method, apparatuses, and non-transitory computer-readable medium described herein may further include operations, features, means, or instructions for initiating a timer based on transmitting the feedback message including the NACK and transmitting, to the base station via the communication link, a second feedback message including a second NACK that indicates the failed reception of the groupcast transmission by the first UE, the second feedback message transmitted based on an expiration of the timer, where the retransmission of the groupcast transmission may be received from the base station based on transmitting the second feedback message.

Some examples of the method, apparatuses, and non-transitory computer-readable medium described herein may further include operations, features, means, or instructions for transmitting, to the second UE via respective sidelink feedback resources, a threshold quantity of feedback messages including respective NACKs that indicate the failed reception of the groupcast transmission by the first UE, the threshold quantity of feedback messages transmitted based on failing to successfully receive or decode the retransmission of the groupcast transmission from the second UE and transmitting, to the base station via the communication link, a second feedback message including a second NACK that indicates the failed reception of the groupcast transmission by the first UE, the second feedback message transmitted based on transmitting the threshold quantity of feedback messages, where the retransmission of the groupcast transmission may be received from the base station based on transmitting the second feedback message.

In some examples of the method, apparatuses, and non-transitory computer-readable medium described herein, the NACK includes an identifier associated with the first UE, a sequence number associated with the groupcast transmission, or both.

Some examples of the method, apparatuses, and non-transitory computer-readable medium described herein may further include operations, features, means, or instructions for transmitting, to the base station via the communication link, a second feedback message including the NACK that indicates the failed reception of the groupcast transmission by the first UE.

In some examples of the method, apparatuses, and non-transitory computer-readable medium described herein, transmitting the feedback message may include operations, features, means, or instructions for broadcasting, over the sidelink feedback resource, the feedback message including the NACK to the group of UEs.

A method for wireless communication at a second UE is described. The method may include receiving, from a base station via a communication link, a groupcast transmission associated with a group of UEs including the second UE, receiving, from a first UE of the group of UEs and via a sidelink feedback resource, a feedback message including a NACK that indicates a failed reception of the groupcast transmission by the first UE, and transmitting, to the first UE via a sidelink resource, a retransmission of the groupcast transmission based on receiving the feedback message including the NACK.

An apparatus for wireless communication at a second UE is described. The apparatus may include a processor, memory coupled with the processor, and instructions stored in the memory. The instructions may be executable by the processor to cause the apparatus to receive, from a base station via a communication link, a groupcast transmission associated with a group of UEs including the second UE, receive, from a first UE of the group of UEs and via a sidelink feedback resource, a feedback message including a NACK that indicates a failed reception of the groupcast transmission by the first UE, and transmit, to the first UE via a sidelink resource, a retransmission of the groupcast transmission based on receiving the feedback message including the NACK.

Another apparatus for wireless communication at a second UE is described. The apparatus may include means for receiving, from a base station via a communication link, a groupcast transmission associated with a group of UEs including the second UE, means for receiving, from a first UE of the group of UEs and via a sidelink feedback resource, a feedback message including a NACK that indicates a failed reception of the groupcast transmission by the first UE, and means for transmitting, to the first UE via a sidelink resource, a retransmission of the groupcast transmission based on receiving the feedback message including the NACK.

A non-transitory computer-readable medium storing code for wireless communication at a second UE is described. The code may include instructions executable by a processor to receive, from a base station via a communication link, a groupcast transmission associated with a group of UEs including the second UE, receive, from a first UE of the group of UEs and via a sidelink feedback resource, a feedback message including a NACK that indicates a failed reception of the groupcast transmission by the first UE, and transmit, to the first UE via a sidelink resource, a retransmission of the groupcast transmission based on receiving the feedback message including the NACK.

Some examples of the method, apparatuses, and non-transitory computer-readable medium described herein may further include operations, features, means, or instructions for receiving, from the first UE via a second sidelink feedback resource, a second feedback message including an ACK that indicates successful reception of the retransmission of the groupcast transmission by the first UE.

Some examples of the method, apparatuses, and non-transitory computer-readable medium described herein may further include operations, features, means, or instructions for receiving, from the base station via the communication link, a message that indicates the sidelink feedback resource for the second UE to use to receive the feedback message including the NACK from the first UE.

Some examples of the method, apparatuses, and non-transitory computer-readable medium described herein may further include operations, features, means, or instructions for receiving, from the base station via the communication link, a message that indicates the sidelink resource for the second UE to use to transmit the retransmission of the groupcast transmission.

In some examples of the method, apparatuses, and non-transitory computer-readable medium described herein, the sidelink resource to use to transmit the retransmission of the groupcast transmission may be based on a mapping that maps the sidelink feedback resource to the sidelink resource.

Some examples of the method, apparatuses, and non-transitory computer-readable medium described herein may further include operations, features, means, or instructions for transmitting, to the first UE and based on receiving the feedback message including the NACK, SCI that reserves the sidelink resource for the retransmission of the groupcast transmission.

Some examples of the method, apparatuses, and non-transitory computer-readable medium described herein may further include operations, features, means, or instructions for measuring a channel metric associated with the feedback message including the NACK, where the retransmission of the groupcast transmission may be transmitted based on the channel metric satisfying a threshold.

In some examples of the method, apparatuses, and non-transitory computer-readable medium described herein, the channel metric includes a signal-to-interference-plus-noise ratio (SINR) associated with the feedback message including the NACK, a reference signal received power (RSRP) associated with the feedback message including the NACK, a reference signal received quality (RSRQ) associated with the feedback message including the NACK, or a combination thereof.

Some examples of the method, apparatuses, and non-transitory computer-readable medium described herein may further include operations, features, means, or instructions for receive, from the base station via the communication link, a message that indicates an association between the sidelink feedback resource and the groupcast transmission, where the NACK indicates the failed reception of the groupcast transmission by the first UE based on at least one of the association between the sidelink resource and the groupcast transmission or an identifier associated with the first UE included in the NACK.

In some examples of the method, apparatuses, and non-transitory computer-readable medium described herein, the NACK indicates the failed reception of the groupcast transmission by the first UE based on at least one of an identifier associated with the first UE included in the NACK or a sequence number associated with the groupcast transmission included in the NACK.

A method for wireless communication at a base station is described. The method may include transmitting, to a group of UEs via a communication link, a groupcast transmission associated with the group of UEs and transmitting, via the communication link, a message indicating a sidelink feedback resource for a UE of the group of UEs to use in transmitting a sidelink feedback message including a NACK that indicates failed reception of the groupcast transmission by the UE.

An apparatus for wireless communication at a base station is described. The apparatus may include a processor, memory coupled with the processor, and instructions stored in the memory. The instructions may be executable by the processor to cause the apparatus to transmit, to a group of UEs via a communication link, a groupcast transmission associated with the group of UEs and transmit, via the communication link, a message indicating a sidelink feedback resource for a UE of the group of UEs to use in transmitting a sidelink feedback message including a NACK that indicates failed reception of the groupcast transmission by the UE.

Another apparatus for wireless communication at a base station is described. The apparatus may include means for transmitting, to a group of UEs via a communication link, a groupcast transmission associated with the group of UEs and means for transmitting, via the communication link, a message indicating a sidelink feedback resource for a UE of the group of UEs to use in transmitting a sidelink feedback message including a NACK that indicates failed reception of the groupcast transmission by the UE.

A non-transitory computer-readable medium storing code for wireless communication at a base station is described. The code may include instructions executable by a processor to transmit, to a group of UEs via a communication link, a groupcast transmission associated with the group of UEs and transmit, via the communication link, a message indicating a sidelink feedback resource for a UE of the group of UEs to use in transmitting a sidelink feedback message including a NACK that indicates failed reception of the groupcast transmission by the UE.

Some examples of the method, apparatuses, and non-transitory computer-readable medium described herein may further include operations, features, means, or instructions for receiving, from the UE via the communication link, a feedback message including the NACK that indicates the failed reception of the groupcast transmission by the UE.

Some examples of the method, apparatuses, and non-transitory computer-readable medium described herein may further include operations, features, means, or instructions for initiating a timer based on receiving the feedback message including the NACK and transmitting, to the UE via the communication link, a retransmission of the groupcast transmission based on an expiration of the timer.

Some examples of the method, apparatuses, and non-transitory computer-readable medium described herein may further include operations, features, means, or instructions for receiving, from the UE via the communication link, a second feedback message including a second NACK that indicates the failed reception of the groupcast transmission by the first UE and transmitting, to the UE via the communication link, a retransmission of the groupcast transmission based on receiving the second feedback message.

Some examples of the method, apparatuses, and non-transitory computer-readable medium described herein may further include operations, features, means, or instructions for transmitting, to the UE and a second UE of the group of UEs, a second message that indicates a sidelink resource for the second UE to use in transmitting a retransmission of the groupcast transmission to the UE.

Some examples of the method, apparatuses, and non-transitory computer-readable medium described herein may further include operations, features, means, or instructions for transmitting, a second UE of the group of UEs, a second message that indicates an association between the sidelink feedback resource and the groupcast transmission.

### BRIEF DESCRIPTION OF THE DRAWINGS

FIGS. 1 and 2 illustrate examples of wireless communications systems that support groupcast retransmission techniques in accordance with aspects of the present disclosure.

FIG. 3 illustrates an example of a mapping diagram that supports groupcast retransmission techniques in accordance with aspects of the present disclosure.

FIG. 4 illustrates an example of a process flow that supports groupcast retransmission techniques in accordance with aspects of the present disclosure.

FIGS. 5 and 6 show block diagrams of devices that support groupcast retransmission techniques in accordance with aspects of the present disclosure.

FIG. 7 shows a block diagram of a communications manager that supports groupcast retransmission techniques in accordance with aspects of the present disclosure.

FIG. 8 shows a diagram of a system including a device that supports groupcast retransmission techniques in accordance with aspects of the present disclosure.

FIGS. 9 and 10 show block diagrams of devices that support groupcast retransmission techniques in accordance with aspects of the present disclosure.

FIG. 11 shows a block diagram of a communications manager that supports groupcast retransmission techniques in accordance with aspects of the present disclosure.

FIG. 12 shows a diagram of a system including a device that supports groupcast retransmission techniques in accordance with aspects of the present disclosure.

FIGS. 13 through 22 show flowcharts illustrating methods that support groupcast retransmission techniques in accordance with aspects of the present disclosure.

### DETAILED DESCRIPTION

Some wireless communication systems may support access links (e.g., a Uu link) and sidelinks (e.g., a PC5 link) for communications between communication devices. Access links may refer to communication links through which a communication device (e.g., a user equipment (UE)) may access a network of a wireless communications system, such as a communication link between a UE and a base station. For example, an access link may support uplink signaling, downlink signaling, connection procedures, etc. Sidelinks may refer to any communication link between similar communication devices (e.g., a communication link between UEs, or a backhaul link between base stations). It is noted that while various examples provided herein are discussed for UE sidelink devices, such sidelink techniques may be used for any type of wireless devices that use sidelink communications. For example, a sidelink may support one or more of device-to-device (D2D) communications, vehicle-to-everything (V2X) or vehicle-to-vehicle (V2V) communications, message relaying, discovery signaling, beacon signaling, or other signals transmitted over-the-air from one UE to one or more other UEs.

Additionally, some wireless communication systems may support groupcast communications in which a group of UEs may be attached to (e.g., communicate with) a base station and downlink transmissions to the group of UEs may be the same. In some examples, a UE of the group of UEs may fail to receive a groupcast transmission from the base station and may transmit a negative acknowledgement (NACK) to the base station to indicate the failed reception of the groupcast transmission by the UE. In response to receiving the NACK, the base station may retransmit the groupcast transmission to the UE. In some cases, if the UE fails to receive the groupcast retransmission, the UE and the base station may continue to communicate NACKs and groupcast retransmissions until the UE successfully receives a groupcast retransmission.

Retransmission of the groupcast transmission may increase its reliability (e.g., the likelihood the groupcast transmission is successfully received). However in some cases, retransmissions by a base station may reduce resource efficiency and increase power consumption. For example, such retransmissions may use additional time and frequency resources of an access link between the base station and a UE for the transmission of redundant data (e.g., data included in the original groupcast transmission). Additionally, the UE and the base station may be located relatively far from each other, and retransmissions across such distances may increase power consumption.

Techniques, systems, and devices are described herein to improve groupcast retransmission methods by enabling groupcast retransmission via sidelink resources. For example, because each UE of a group of UEs receives a same groupcast transmission from a base station, a UE that successfully receives the groupcast transmission may retransmit the groupcast transmission to a UE that failed to receive the original groupcast transmission. To support such UE-to-UE groupcast retransmissions, a base station may indicate a sidelink feedback resource (e.g., of a physical sidelink feedback channel (PSFCH)) to a group of UEs that the UEs may use to indicate failed reception of a groupcast transmission from the base station. For example, the base station may transmit a groupcast transmission to the group of UEs, and a first UE of the group of UEs may fail to receive the groupcast transmission. The first UE may transmit a NACK indicating the failed reception of the groupcast transmission to the group of UEs via the indicated sidelink feedback resource (and, additionally, to the base station via an access link in some examples). In response to receiving the NACK, a second UE of the group of UEs may retransmit the groupcast transmission to the first UE via a sidelink resource (e.g., of a physical sidelink shared channel (PSSCH).

The first UE may monitor the sidelink resource for the groupcast retransmission. If the first UE successfully receives the groupcast retransmission from the second UE, the first UE may transmit an acknowledgement (ACK) to the group of UEs and the base station indicating the successful reception. Alternatively, if the first UE fails to receive the groupcast retransmission, the first UE may transmit a second NACK to the group of UEs, the base station, or both. In some examples, the first UE may receive a second retransmission of the groupcast transmission from the group of UEs (e.g., from the second UE) in response to transmitting the second NACK. In some examples, the base station may retransmit the groupcast transmission to the first UE, for example, in response to receiving the second NACK or not receiving the ACK from the first UE within some period of time after transmitting the groupcast transmission.

Aspects of the subject matter described in this disclosure may be implemented to realize one or more of the following potential improvements, among others. The techniques employed by the described communication devices may enable the communication of groupcast retransmissions between UEs via sidelink resources, which may increase resource usage efficiency, reduce power consumption, and reduce latency associated with communicating groupcast retransmissions. For example, retransmitting groupcast transmissions via sidelink resources (e.g., instead of access link resources) may reduce congestion of an access link and usage of access link time and frequency resources. Additionally, UEs of a group of UEs that communicate groupcast retransmissions may be relatively closer to one another as compared to a base station, and thus groupcast retransmissions may travel a shorter distance, thereby reducing latency and power consumption. In some examples, sidelink resources may be more readily available than access link resources and, as a result, a groupcast retransmission may be transmitted relatively sooner over a sidelink resource than an access link resource, thereby further reducing latency. In some examples, communicating groupcast retransmissions via UEs of a group may reduce signaling overhead between a UE and a base station, increase coordination between communication devices, and increase battery life, among other benefits.

Aspects of the disclosure are initially described in the context of wireless communications systems. Aspects of the disclosure are additionally described in the context of a mapping diagram and a process flow. Aspects of the disclosure are further illustrated by and described with reference to apparatus diagrams, system diagrams, and flowcharts that relate to groupcast retransmission techniques.

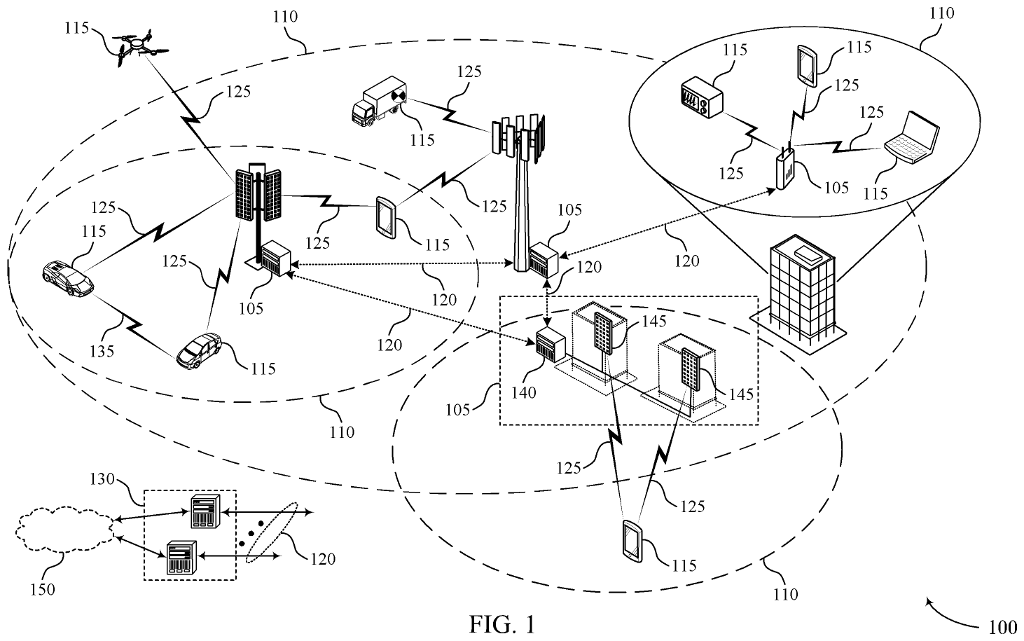

FIG. 1 illustrates an example of a wireless communications system 100 that supports groupcast retransmission techniques in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In some examples, the wireless communications system 100 may be an example of a sidelink network. Here, the sidelink network may support one or more resource allocation modes to coordinate sidelink communications between UEs 115 (e.g., over D2D communication links 135, over PC5 links). For example, the sidelink network may be configurable to operate according a Mode 1 resource allocation mode and/or a Mode 2 resource allocation mode. While operating in Mode 1, the sidelink network (e.g., sidelink communications over the sidelink network) may be managed (e.g., coordinated) by a base station 105. For example, during Mode 1 operation, the base station 105 may manage sidelink resource allocation over the sidelink network. For instance, the base station 105 may transmit sidelink resource grants to UEs 115 of the sidelink network that schedule sidelink communications over the sidelink network.

While operating in Mode 2, the sidelink network may not be managed or coordinated by the base station 105. Without coordination or management of sidelink resources of the sidelink network during the Mode 2 operation, UEs 115 may follow contention-based access procedures in which the various UEs 115 may reserve sidelink resources of the sidelink network. For example, during Mode 2 operation, a UE 115 may monitor the sidelink network to determine if other UEs 115 are attempting to transmit over the sidelink network. For instance, the UE 115 may decode one or more reservation messages (e.g., sidelink control channel transmissions such as sidelink control information (SCI) messages, SCI-1 messages, SCI-2 messages, request-to-send-messages, or some other sidelink control channel transmissions) and may determine which sidelink resources are reserved for other sidelink communications and which sidelink resources are available for sidelink communications based on the reservation messages. In some examples, the UE 115 may determine whether a sidelink resource is reserved based on measuring a reference signal received power (RSRP) of an associated reservation message. In some cases, the UE 115 may determine which sidelink resources are available for sidelink communications based on reservation messages decoded during a sensing window, where the sensing window corresponds to some duration of time prior to the arrival of a packet of information. In some examples, the packet arrival may trigger the UE 115 to determine which sidelink resources are available and to reserve sidelink resources.

In some examples, UEs 115 may be configured with one or more sidelink resource pools from which to select and reserve sidelink resources (e.g., during Mode 2 operation). In some cases, sidelink resource pools may include transmit sidelink resource pools (e.g., sets of sidelink resources over which the UE 115 may transmit sidelink messages) and receive sidelink resource pools (e.g., sets of sidelink resources over which the UE 115 may receive sidelink messages). The sidelink resource pools may be configured for Mode 1 communications or for Mode 2 communications. In some examples, a sidelink resource pool configuration for a sidelink resource pool may include a PSSCH configuration, a physical sidelink control channel (PSCCH) configuration, a PSFCH configuration, a quantity of subchannels in the sidelink resource pool, a subchannel size (e.g., bandwidth), a starting resource block of the sidelink resource pool, a modulation and coding scheme (MCS) associated with the sidelink resource pool, a sensing configuration, a power control configuration, a constant bit rate (CBR), or a combination thereof.

The wireless communications system 100 may support groupcast communications between a group of UEs 115 and a base station 105. For example, the group of UEs 115 may be attached to the base station 105 such that downlink transmissions (e.g., in downlink transport blocks (TBs)) to the group of UEs 115 are the same. That is, the base station 105 may transmit (e.g., broadcast) a same groupcast message to each UE 115 of the group of UEs 115. The group of UEs 115 may be within a coverage area 110 of the base station 105. In some examples, the groupcast message may be an example of a same video stream or video game stream that is common to the group of UEs 115, among other examples of groupcast messages.

In some examples, a UE 115 of the group of UEs 115 may fail to receive or decode a groupcast transmission from the base station 105. In some cases, the base station 105 may retransmit the groupcast transmission to the UE 115. However, such retransmissions by the base station 105 may increase congestion and signaling overhead of a communication link 125 (e.g., an access link) between the base station 105 and the UE 115, increase power consumption, and increase latency.

Various aspects of the described techniques support the retransmission of a groupcast transmission by UEs 115 of a group of UEs 115 via sidelink resources. For example, a first UE 115 of the group of UEs 115 that fails to receive the groupcast transmission may transmit a NACK to one or more UEs 115 of the group of UEs 115 to indicate the failed reception of the groupcast transmission by the first UE 115. The first UE 115 may transmit the NACK to the one or more UEs 115 using a sidelink feedback resource (e.g., of a PSFCH) that is indicated (e.g., allocated) by the base station 105 (e.g., in accordance with a Mode 1 resource allocation mode). In response to receiving the NACK, the one or more UEs 115 may retransmit the groupcast transmission to the first UE 115 via one or more sidelink resources (e.g., of a PSSCH). The first UE 115 may monitor the one or more sidelink resources and may receive the retransmission of the groupcast transmission from the one or more UEs 115. In this way, the group of UEs 115 may communicate groupcast retransmissions via sidelink resources instead of receiving groupcast retransmissions via access link resources, thereby improving resource usage efficiency, latency, and power consumption, among other benefits.

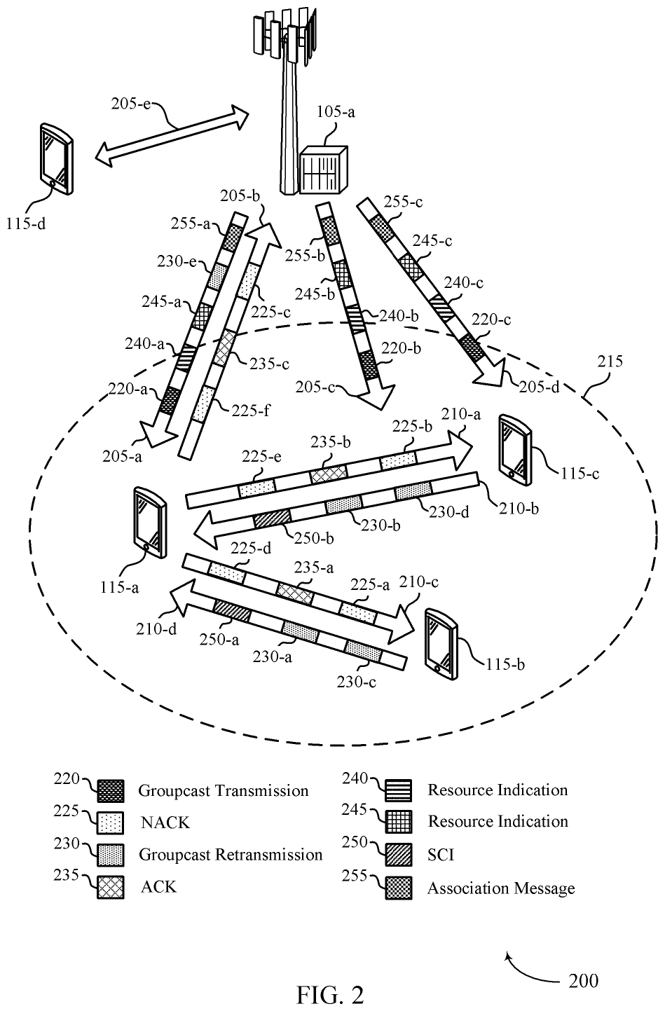

FIG. 2 illustrates an example of a wireless communications system 200 that supports groupcast retransmission techniques in accordance with aspects of the present disclosure. The wireless communications system 200 may implement aspects of the wireless communications system 100 or may be implemented by aspects of the wireless communications system 100. For example, the wireless communications system 200 may include a base station 105-a, a ULE 115-a, a UE 115-b, a UE 115-c, and a UE 115-d, which may be examples of the corresponding devices described with reference to FIG. 1. In some examples, the base station 105-a and the UEs 115 may support the retransmission of groupcast transmissions via sidelink channels to provide improvements to resource usage efficiency, power consumption, latency, signaling overhead, channel congestion, reliability, data rates, coordination between devices, and spectral efficiency, among other benefits.

The wireless communications system 200 may support communications between the base station 105-a and the UEs 115 over various communication links 205, which may be examples of an access link or a communication link 125 as described with reference to FIG. 1. For example, the base station 105-a may transmit downlink messages to the UE 115-a over the communication link 205-a, to the UE 115-b over the communication link 205-c, to the UE 115-c over the communication link 205-d, and to the UE 115-d over the communication link 205-e. Additionally, the base station 105-a may receive uplink messages from the UE 115-a over the communication link 205-b and from the UE 115-d over the communication link 205-e.

The wireless communications system 200 may also support communications between the UEs 115 over various sidelinks 210, which may be examples of a D2D communication link 135 as described with reference to FIG. 1. For example, the UE 115-a may transmit sidelink messages to the UE 115-b over a sidelink 210-a and to the UE 115-c over a sidelink 210-c. Additionally, the UE 115-a may receive sidelink messages from the UE 115-b over a sidelink 210-b and from the UE 115-c over a sidelink 210-d. In some examples, the sidelinks 210 may be examples of a physical sidelink channel such as a PSSCH, a PSCCH, or a PSFCH, among other examples of physical sidelink channels.

The wireless communications system 200 may support groupcast communications between the base station 105-a and a group of UEs 215. For example, the base station 105-a may transmit groupcast transmissions 220 to the group of UEs 215, where each groupcast transmission 220 may be a same message that is transmitted (e.g., broadcasted) to the UEs 115 of the group of UEs 215. In the example of FIG. 2, the group of UEs 215 may include the UE 115-a, the UE 115-b, and the UE 115-c, while the UE 115-d may be excluded from the group of UEs 215. It is noted, however, that the techniques described herein may be adapted and applied such that any quantity of UEs 115 within a coverage area of the base station 105-a may be included in the group of UEs 215.

The UEs 115 of the group of UEs 215 may monitor allocated (e.g., configured) resources of the respective communication links 205 for a groupcast transmission 220 from the base station 105-a that is transmitted in a downlink TB (e.g., a downlink TBₖ). For example, the base station 105-a may transmit, in the downlink TBₖ, a groupcast transmission 220-a to the UE 115-a, a groupcast transmission 220-b to the UE 115-b, and a groupcast transmission 220-c to the UE 115-c, where the groupcast transmission 220-a, the groupcast transmission 220-b, and the groupcast transmission 220-c may be a same groupcast transmission 220 (e.g., may each include the same information or data). In some cases, one or more UEs 115 of the group of UEs 215 may fail to properly receive or decode the groupcast transmission 220. For example, in the example of FIG. 2, the UE 115-a (e.g., a UEⱼ 115) may fail to receive or decode the groupcast transmission 220-a.

One or more UEs 115 of the group of UEs 215 may be configured to provide a retransmission of the groupcast transmission 220 to a UE 115 that failed to receive or decode the groupcast transmission 220. For example, the UE 115-b and the UE 115-c may successfully receive and decode the groupcast transmission 220-b and the groupcast transmission 220-c, respectively. Accordingly, one or more of the UE 115-b and the UE 115-c may be configured to transmit a groupcast retransmission 230 to the UE 115-a that corresponds to (e.g., includes the same information or data as) the groupcast transmission 220-a. In some examples, groupcast retransmissions 230 may increase a reliability of a groupcast transmission 220, for example, by providing additional opportunities for a UE 115 to receive and decode the information or data included in the groupcast transmission 220.

To support communication of groupcast retransmissions 230 by the UEs 115 of the group of UEs 215, a UE 115 may be configured to transmit a NACK 225 to one or more UEs 115 of the group of UEs 215 (e.g., as part of a HARQ process). For example, when the downlink TBₖ is not decoded successfully by the UEⱼ 115 (e.g., the UE 115-a), the UEⱼ 115 may broadcast a NACKⱼₖ to adjacent UEs 115 of the group of UEs 215 over the sidelinks 210 (e.g., over a PC5 link) to indicate a failed reception of the downlink TBₖ by the UEⱼ 115. The UEⱼ 115 may also feedback the NACKⱼₖ to the base station 105-a over a PUCCH, where the HARQ process is not released until the base station 105-a receives an ACKⱼₖ from the UEⱼ 115 indicating successful reception of the downlink TBₖ. The adjacent UEs 115 may be expected to retransmit the downlink TBₖ (e.g., via a groupcast retransmission 230) to the UEⱼ 115 over the PC5 link.

For example, the UE 115-a may transmit a NACK 225 (e.g., as part of a HARQ process) to one or more of the UEs 115 of the group of UEs 215 that indicates the failed reception (e.g., or decoding) of the groupcast transmission 220-a. For instance, the UE 115-a may transmit a NACK 225-a to the UE 115-b, a NACK 225-b to the UE 115-c, or both, to indicate that the UE 115-a failed to properly receive or decode the groupcast transmission 220-a. In some examples, the UE 115-a may broadcast the NACK 225 to the group of UEs 215 over the sidelinks 210 (e.g., the NACK 225-a and the NACK 225-b may be a same NACK 225 broadcasted to the UE 115-b and the UE 115-c). In some examples, the UE 115-a may also transmit a NACK 225-c to the base station 105-a (e.g., via a physical uplink control channel (PUCCH)) to inform the base station 105-a of the failed reception of the groupcast transmission 220-a by the UE 115-a.

The UE 115-a may transmit the NACK 225-a, the NACK 225-b, or both (e.g., the broadcasted NACK 225), via a sidelink feedback resource (e.g., a PSFCH resource). In some examples, the UE 115-a may reserve the sidelink feedback resource by transmitting a reservation message (e.g., SCI) to the UE 115-b and the UE 115-c. In some examples, the base station 105-a may indicate to the group of UEs 215 the sidelink feedback resource for transmission of the NACK 225. For example, the base station 105-a may transmit (e.g., broadcast) a resource indication 240 that indicates the sidelink feedback resource (e.g., the PSFCH resource) that a UE 115 of the group of UEs 215 may use to transmit a NACK 225 to one or more other UEs 115 of the group of UEs 215 in response to failing to receive or decode a groupcast transmission 220. For instance, the base station 105-a may transmit a resource indication 240-a to the UE 115-a, a resource indication 240-b to the UE 115-b, and a resource indication 240-c to the UE 115-c, each of which indicate the sidelink feedback resource. Accordingly, the UE 115-a may determine the sidelink feedback resource to use to transmit the NACK 225, and the UE 115-b and the UE 115-c may determine the sidelink feedback resource to monitor for the NACK 225.

In some examples, the base station 105-a may transmit the resource indication 240 in downlink control information (DCI). For example, the base station 105-a may indicate the PSFCH resource to the group of UEs 215 via DCI associated with a downlink groupcast PDSCH (e.g., a PDSCH carrying the downlink TBₖ). The DCI may include a frequency domain resource field, a time domain resource field, or both, for a PSFCH that indicates the sidelink feedback resource of the PSFCH for communicating the NACK 225. In some examples, the base station 105-a may inform the group of UEs 215 of the sidelink feedback resource via a DCI 3-0 (e.g., a DCI having a format 3-0). For example, the base station 105-a may transmit a DCI that schedules a physical downlink shared channel (PDSCH) transmission (e.g., the groupcast transmission 220) and may transmit another DCI (e.g., the DCI 3-0) to the group of UEs 215 that includes the frequency domain resource field, the time domain resource field, or both, for the PSFCH.

In some examples, the base station 105-a may transmit the resource indication 240 in RRC signaling (e.g., a resource for PSFCH may be based on a configured grant that is RRC-based). For example, the resource indication 240 may indicate a configured grant assigned for the sidelink feedback resource in an RRC message.

In response to receiving the NACK 225, one or more of the UEs 115 of the group of UEs 215 may transmit a groupcast retransmission 230 to the UE 115-a. For example, the UE 115-b may transmit a groupcast retransmission 230-a to the UE 115-a via a first sidelink resource (e.g., of a PSSCH), the UE 115-c may transmit a groupcast retransmission 230-b to the UE 115-a via a second sidelink resource (e.g., of a PSSCH), or both. In some examples, the first sidelink resource and the second sidelink resource may be a same sidelink resource (e.g., of a sidelink resource pool). In some other examples, the first sidelink resource and the second sidelink resource may be different sidelink resources. In some examples, the UE 115-a may merge (e.g., combine) the groupcast retransmissions 230 (e.g., the groupcast retransmission 230-a, the groupcast retransmission 230-b, or both) and the groupcast transmission 220-a using a chase combination scheme to increase a likelihood that the UE 115-a successfully decodes the information included in the groupcast retransmissions 230 and the groupcast transmission 220-a. For example, because each of the groupcast transmission 220-a and the groupcast retransmissions 230 include the same bits of information, the UE 115-a may combine the decoded bits from the groupcast transmission 220-a and the groupcast retransmissions 230 using, for example, maximum ratio combining or a log likelihood ratio to increase the likelihood that the UE 115-a successfully decodes the groupcast retransmissions 230.

The UEs 115 of the group of UEs 215 may determine sidelink resources for communicating the groupcast retransmissions 230 (e.g., the first sidelink resource and the second sidelink resource) according to various methods. In some examples, the base station 105-a may transmit a resource indication 245 that indicates the sidelink resources (e.g., the first sidelink resource and the second sidelink resource), for example, in accordance with a Mode 1 resource allocation mode. For example, the base station 105-a may transmit a resource indication 245-a to the UE 115-a, a resource indication 245-b to the UE 115-b, and a resource indication 245-c to the UE 115-c that indicate one or more of the first sidelink resource and the second sidelink resource. In some examples, the base station 105-a may transmit the resource indications 245 in a MAC-control element (MAC-CE) that schedules the first sidelink resource, the second sidelink resource, or both. For example, the base station 105-a may schedule a PSSCH resource for a retransmission of the downlink TBₖ in advance via the MAC-CE transmitted on a PDSCH associated with the downlink TBₖ (e.g., before transmitting the downlink TBₖ, concurrent with transmitting the downlink TBₖ, over a same PDSCH that carries the downlink TBₖ). In some examples, the base station 105-a may transmit the resource indications 245 in DCI, for example, in response to receiving the NACK 225-c from the UE 115-a. For example, after receiving the NACKⱼₖ, the base station 105-a may send DCI to indicate the PSSCH resource to the group of UEs 215 for the retransmission of the downlink TBₖ. In some cases, this may reduce signaling overhead between the UEs 115 and the base station 105-a and increase sidelink resource availability, for example, by refraining from scheduling the sidelink resources via the DCI until receiving confirmation that at least one of the UEs 115 of the group of UEs 215 failed to receive the groupcast transmission 220.

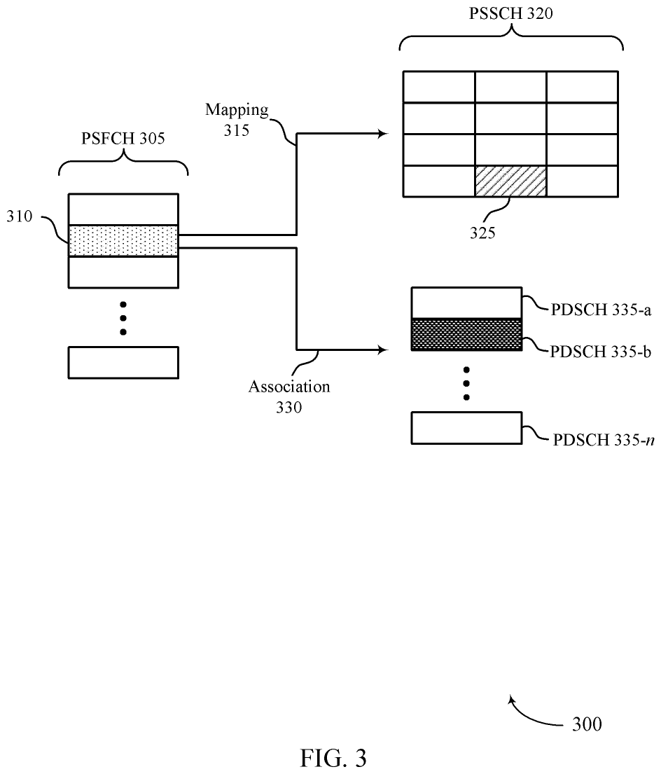

In some examples, the resource indication 245 may indicate the sidelink resources by indicating (e.g., configuring the group of UEs 215 with) a mapping between the sidelink feedback resource that carries the NACK 225 and the sidelink resource. For example, the mapping may map the time and frequency location of the sidelink feedback resource to the sidelink resource that a UE 115 of the group of UEs 215 is to use to transmit a groupcast retransmission 230. Accordingly, the UEs 115 of the group of UEs 215 may determine a PSSCH resource for retransmission of the downlink TBₖ by using a mapping between the PSSCH resource and a location of a NACK 225 (e.g., the NACKⱼₖ). Additional details related to implementing the mapping to determine sidelink resources for the communication of groupcast retransmissions 230 are described with reference to FIG. 3 below.

In some examples, one or more of the UE 115-b and the UE 115-c may automatically preempt sidelink resources of a sidelink resource pool for transmitting respective groupcast retransmissions 230, for example, in accordance with a Mode 2 resource allocation mode. For example, the UE 115-b may transmit SCI 250-a to the UE 115-a (e.g., and to the UE 115-c) that reserves the first sidelink resource for transmission of the groupcast retransmission 230-a by the UE 115-b. Additionally, or alternatively, the UE 115-c may transmit SCI 250-b to the UE 115-a (e.g., and the UE 115-b) that reserves the second sidelink resource for transmission of the groupcast retransmission 230-b by the UE 115-c.

The UEs 115 of the group of UEs 215 may determine which UEs 115 will retransmit the downlink TBₖ to the UEⱼ 115, for example, after receiving the NACKⱼₖ. In some examples, the UE 115-b and the UE 115-c may determine whether to transmit a respective groupcast retransmission 230 to the UE 115-a in response to receiving the NACK 225-a and the NACK 225-b, respectively. For example, the UE 115-a and the UE 115-b may determine to transmit, respectively, the groupcast retransmission 230-a and the groupcast retransmission 230-b in response to successfully decoding the NACK 225-a and the NACK 225-b, respectively.

In some examples, the UE 115-b and the UE 115-c may determine whether to transmit the respective groupcast retransmissions 230 based on a channel metric associated with the NACKs 225 (e.g., a channel metricⱼₖ corresponding to the NACKⱼₖ). For example, the UE 115-b may measure a first channel metric associated with the NACK 225-a and compare the first channel metric to a threshold, and the UE 115-c may measure a second channel metric associated with the NACK 225-b and compare the second channel metric to the threshold. If the first channel metric satisfies (e.g., meets or exceeds) the threshold, the UE 115-b may be configured to transmit the groupcast retransmission 230-a. Otherwise, the UE 115-b may be configured to refrain from transmitting the groupcast retransmission 230-a. If the second channel metric satisfies (e.g., meets or exceeds) the threshold, the UE 115-c may be configured to transmit the groupcast retransmission 230-b. Otherwise, the UE 115-c may refrain from transmitting the groupcast retransmission 230-b. In some examples, the measured channel metrics may be a signal-to-interference-plus-noise ratio (SINR) of the respective NACKs 225 (e.g., an SINRⱼₖ), a reference signal received power (RSRP) of the respective NACKs 225 (e.g., an RSRPⱼₖ), a reference signal received quality (RSRQ) of the respective NACKs 225 (e.g., an RSRQⱼₖ), or a combination thereof. Thus, the threshold may be a threshold SINR (e.g., a threshold SINRₜₕ), a threshold RSRP (e.g., a threshold RSRPₜₕ), a threshold RSRQ (e.g., a threshold RSRQₜₕ), or a threshold corresponding to some combination of SINR, RSRP, or RSRQ. In some examples, the base station 105-a may configure the threshold. In some examples, the threshold may be pre-configured at the UEs 115 of the group of UEs 215 (e.g., may be a preset threshold). In some examples, using the threshold to determine whether to transmit a groupcast retransmission 230 may increase a likelihood (e.g., guarantee) that different groupcast retransmissions 230 from different UEs 115 may be combined using single frequency network techniques at the UEⱼ 115 (e.g., and merged using a chase combination scheme).

The UE 115-b and the UE 115-c may determine to which UE 115 of the group of UEs 215 to transmit the respective groupcast retransmissions 230 based on the NACKs 225. For example, the NACK 225-a and the NACK 225-b may include an identifier of the UE 115-a. Accordingly, by decoding the NACKs 225, the UE 115-b and the UE 115-c may determine that the UE 115-a transmitted the respective NACKs 225 and failed to receive the groupcast transmission 220-a. Thus, the UE 115-b and the UE 115-c may determine to transmit the respective groupcast retransmissions 230 to the UE 115-a.

The UEs 115 of the group of UEs 215 (e.g., the adjacent UEs 115) may determine which downlink TB to retransmit to the UEⱼ 115. For example, the UE 115-b and the UE 115-c may determine which groupcast transmission 220 to retransmit based on the NACKs 225. For example, the base station 105-a may transmit the groupcast transmission 220 in the downlink TBₖ, which may be associated with a sequence number of a sequence of downlink TBs transmitted by the base station 105-a. In some examples, the NACK 225-a and the NACK 225-b (e.g., the NACKⱼₖ) may include the sequence number associated with the downlink TBₖ, thereby indicating which groupcast transmission 220 the UE 115-a failed to receive. In some cases, the base station 105-a may refrain from transmitting a next groupcast transmission 220 (e.g., a next downlink TB) until it receives an ACK 235 indicating successful reception of the groupcast transmission 220 from each of the UEs 115 of the group of UEs. Here, the UE 115-b and the UE 115-c may determine that the groupcast transmission 220 that the UE 115-a failed to receive corresponds to the most recent groupcast transmission 220 (e.g., included in the downlink TBₖ) transmitted by the base station 105-a.

In some examples, the adjacent UEs 115 may determine the downlink TB for retransmission to the UEⱼ 115 using an association (e.g., a mapping) between a PSFCH subchannel and a PDSCH (e.g., that carries the downlink TB). Accordingly, when the adjacent UEs 115 receive the NACKⱼₖ transmitted on a given PSFCH subchannel, the adjacent UEs 115 may deduce (e.g., determine) the downlink TBₖ for retransmission. For example, the base station 105-a may transmit an association message 255 to the group of UEs 215 that indicates an association (e.g., a mapping) between sidelink feedback resources (e.g., PSFCH subchannels) and groupcast transmissions 220 (e.g., PDSCHs carrying downlink TBs). For instance, the base station 105-a may transmit an association message 255-a to the UE 115-a, an association message 255-b to the UE 115-b, and an association message 255-c to the UE 115-c that each indicate the association between the sidelink feedback resources and the groupcast transmissions 220. Additional details related to the association between the sidelink feedback resources and the groupcast transmission 220 are described with reference to FIG. 3 below.

In some examples, the association between PSFCH subchannels and PDSCHs carrying downlink TBs may be established in advance at the base station 105-a. In some examples, the base station 105-a may transmit the association messages 255 (e.g., convey the association) in a MAC-CE over a PDSCH. In some examples, the base station 105-a may transmit the association messages (e.g., convey the association) in DCI associated with the PDSCH carrying the downlink TBₖ. The UE 115-a may transmit the NACKs 225 to the UE 115-b and the UE 115-c in accordance with the association between the sidelink feedback resources and the groupcast transmissions 220 to indicate that the UE 115-a failed to receive the groupcast transmission 220-a. The UE 115-b and the UE 115-b may use the association between the sidelink feedback resources and the groupcast transmissions 220 to determine that the UE 115-a failed to receive the groupcast transmission 220-a.

Based on determining which groupcast transmission 220 the UE 115-a failed to receive, the UE 115-b, the UE 115-c, or both, may transmit, respectively, the groupcast retransmission 230-a and the groupcast retransmission 230-b to the UE 115-a via the determined sidelink resources (e.g., via the first sidelink resource, the second sidelink resource, or both). The UE 115-a may monitor the determined sidelink resources for the groupcast retransmissions 230. If the UE 115-a successfully receives one or more of the groupcast retransmissions 230 as a result of the monitoring, the UE 115-a may transmit an ACK 235 to the group of UEs 215 and to the base station 105-a that indicates the successful reception of the one or more groupcast retransmissions 230 (e.g., that the UE 115-a successfully received and decoded the information included in the groupcast transmission 220-a). For example, the UE 115-a may transmit an ACK 235-a to the UE 115-b, an ACK 235-b to the UE 115-c, and an ACK 235-c to the base station 105-a. In response to receiving the ACK 235-c, the base station 105-c may release the HARQ process associated with the groupcast transmission 220. That is, if the UEⱼ 115 receives and decodes the retransmission of the downlink TBₖ from the adjacent UEs 115 successfully, the UEⱼ 115 may broadcast an ACKⱼₖ to the adjacent UEs 115 in the group of UEs 215 over the sidelinks 210 (e.g., over a PC5 link). The UEⱼ 115 may also feedback the ACKⱼₖ to the base station 105-a over a PUCCH, and the base station 105-a may release the HARQ process.

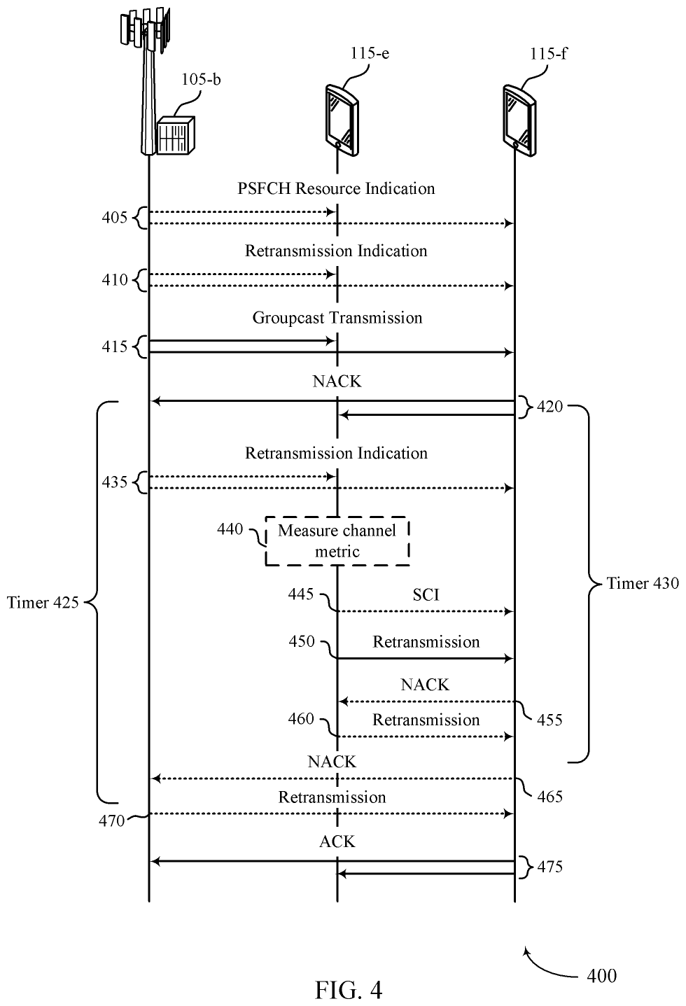

Alternatively, in some cases, if the UEⱼ does not receive the retransmission of the downlink TBₖ from the adjacent UEs 115 within a preconfigured period, the base station 105-a may retransmit the downlink TBₖ to the UEⱼ in accordance with the HARQ process on a PDSCH. For example, if the UE 115-a fails to receive the groupcast retransmissions 230 within the preconfigured period (e.g., before an expiration of a timer 425 or a timer 430 described with reference to FIG. 4 below), the UE 115-a may transmit a NACK 225-f (e.g., the NACKⱼₖ) to the base station 105-a to indicate the failed reception of the groupcast transmission 220-a. In response to the NACK 225-f, the base station 105-a may transmit a groupcast retransmission 230-e (e.g., corresponding to the downlink TBₖ) to the UE 115-a.

In some other cases, the UE 115-a may transmit another NACK 225 to the group of UEs 215 in response to failing to receive and decode the groupcast retransmissions 230 via the sidelink resources (e.g., the groupcast retransmission 230-a, the groupcast retransmission 230-b). For instance, the UE 115-a may transmit a NACK 225-d to the UE 115-b and/or a NACK 225-e to the UE 115-c (e.g., via sidelink feedback resources indicated by the base station 105-a). In response to NACK 225-d and the NACK 225-e, one or more of the UE 115-b and the UE 115-c may transmit another groupcast retransmission 230 to the UE 115-a. For example, the UE 115-b may transmit a groupcast retransmission 230-c, or the UE 115-c may transmit a groupcast retransmission 230-d, or both.

In some examples, the UE 115-a may communicate NACKs 225 and groupcast retransmissions 230 until the UE 115-a successfully receives and decodes a groupcast retransmission 230 via a sidelink resource. In some other examples, the UE 115-a may be configured to transmit a threshold quantity of NACKs 225 to the group of UEs 215. Here, the UE 115-a may be configured to transmit the NACK 225-f to the base station 105-a upon transmitting the threshold quantity of NACKs 225 to the group of UEs 215 without successfully receiving a groupcast retransmission 230 via a sidelink resource.

FIG. 3 illustrates an example of a mapping diagram 300 that supports groupcast retransmission techniques in accordance with aspects of the present disclosure. The mapping diagram 300 may implement or be implemented by aspects of the wireless communications systems 100 and 200 as described with reference to FIGS. 1 and 2, respectively. For example, the mapping diagram 300 may be implemented by a UE 115 to enable groupcast retransmissions via sidelink resources.

The mapping diagram 300 depicts a mapping 315 that may be implemented by a first UE 115 to determine which sidelink resource to monitor for a groupcast retransmission, for example, if the first UE 115 failed to receive a groupcast transmission transmitted by a base station 105. Alternatively, the mapping 315 may be implemented by a second UE 115 to determine which sidelink resource to use to transmit the groupcast retransmission to the first UE 115 that failed to receive the groupcast transmission (e.g., in response to receiving a NACK from the first UE 115). For example, the mapping 315 may map a PSFCH resource 310 of a PSFCH 305 to a PSSCH resource of a PSSCH 320. The PSFCH resource 310 may correspond to a sidelink feedback resource via which the NACK indicating the failed reception of the groupcast transmission is communicated. The PSSCH resource 325 may correspond to the sidelink resource via which the groupcast retransmission is communicated. In some examples, the first UE 115, the second UE 115, or both, may be configured with the mapping 315 via a resource indication 245 described with reference to FIG. 2.

The mapping 315 may map the PSFCH resource 310 to the PSSCH resource 325 based on a location of the PSFCH resource 310 within the PSFCH 305. For example, the mapping 315 may map different time and frequency locations of the PSFCH resource 310 to different time and frequency locations of the PSSCH resource 325. Therefore, the first UE 115 that transmits the NACK via the PSFCH resource 310 may use the mapping 315 to determine to monitor for the groupcast retransmission in the PSSCH resource 325. Additionally, the second UE 115 that receives the NACK via the PSFCH resource 310 may use the mapping 315 to determine to transmit the groupcast retransmission in the PSSCH resource 325.

The mapping diagram 300 also depicts an association 330 that may be implemented by the first UE 115 to indicate which groupcast transmission from the base station 105 that the first UE 115 failed to receive or decode. Alternatively, the association 330 may be implemented by the second UE 115 to determine to which groupcast transmission from the base station 105 the first UE 115 failed to receive or decode. In some examples, the first UE 115, the second UE, or both, may be configured with the association 330 via an association message 255 described with reference to FIG. 2.

The association 330 may indicate an association between the PSFCH resource 310 and a PDSCH 335 (e.g., map the PSFCH resource 310 to the PDSCH 335) via which the base station 105 transmits the groupcast transmission. For example, the base station 105 may transmit different groupcast transmissions via different PDSCHs 335 (e.g., a PDSCH 335-a through a PDSCH 335-n). The association 330 may associate the PSFCH resource 310 with a PDSCH 335-b (e.g., map the PSFCH resource 310 to the PDSCH 335-b) based on a location of the PSFCH resource 310 within the PSFCH 305. For example, the association 330 may associate different subchannels of the PSFCH 305 with different PDSCHs 335. Therefore, the first UE 115 may indicate which groupcast transmission the first UE 115 failed to receive based on the subchannel of the PSFCH resource 310. Additionally, the second UE 115 may use the association 330 to determine that the first UE 115 failed to receive the groupcast transmission transmitted via the PDSCH 335-b. Accordingly, the second UE 115 may transmit a groupcast retransmission to the first UE 115 (e.g., via the PSSCH resource 325) that corresponds to the groupcast transmission transmitted via the PDSCH 335-b.

FIG. 4 illustrates an example of a process flow 400 that supports groupcast retransmission techniques in accordance with aspects of the present disclosure. In some examples, the process flow 400 may implement or be implemented by aspects of a wireless communications system 100 and 200 as described with reference to FIGS. 1 and 2. For example, the process flow 400 may be implemented by a base station 105-b, a UE 115-e, and a UE 115-f to support the UE retransmission of groupcast messages via sidelink resources.

The base station 105-b, the UE 115-e, and the UE 115-f may be examples of a base station 105 or a UE 115, as described with reference to FIGS. 1 through 3. The UE 115-e and the UE 115-f may be included in a group of UEs 115 that may receive groupcast transmissions from the base station 105-b. In the example of FIG. 4, the UE 115-f may be an example of a UEⱼ 115 described with reference to FIG. 2.

In the following description of the process flow 400, the operations between the base station 105-b, the UE 115-e, and the UE 115-f may be communicated in a different order than the example order shown, or the operations performed by the base station 105-b, the UE 115-e, and the UE 115-f may be performed in different orders or at different times. Some operations may also be omitted from the process flow 400, and other operations may be added to the process flow 400. Further, although some operations or signaling may be shown to occur at different times for discussion purposes, these operations may actually occur at the same time.

At 405, the base station 105-b may transmit a PSFCH resource indication to the UE 115-e and the UE 115-f via an access link. The PSFCH resource indication may indicate a PSFCH resource via which the UE 115-e and the UE 115-f may communicate a NACK (e.g., a NACKⱼₖ) indicating a failed reception of a groupcast transmission from the base station 105-b (e.g., communicated via a downlink TBₖ). In some examples, the base station 105-b may transmit the PSFCH resource indication via DCI or RRC signaling. In some examples, the PSFCH resource indication may be an example of a resource indication 240 described with reference to FIG. 2. In some examples, the base station 105-b may transmit the PSFCH resource indication to the UE 115-e and the UE 115-f as a groupcast message.

At 410, the base station 105-b may transmit a retransmission indication to the UE 115-e and the UE 115-f via the access link. In some examples, the retransmission indication may indicate a PSSCH resource via which the UE 115-e and the UE 115-f may communicate a groupcast retransmission corresponding to groupcast transmission (e.g., a retransmission of the downlink TBₖ), for example, in response to communicating the NACK. For example, the base station 105-b may transmit the retransmission indication in a MAC-CE that schedules the PSSCH resource for communication of the groupcast retransmission between the UE 115-e and the UE 115-f. In some other examples, the retransmission indication may indicate a mapping between the PSFCH resource and the PSSCH resource (e.g., a mapping 315 described with reference to FIG. 3). The mapping may map a location of the PSFCH resource in time, frequency, or both, to the PSSCH resource within a PSSCH. In some examples, the base station 105-b may transmit the retransmission indication in an RRC message that includes and configures the UE 115-e and the UE 115-f with the mapping. In some examples, the retransmission indication may be an example of a resource indication 245 described with reference to FIG. 2.

In some examples, the retransmission indication may indicate an association (e.g., a mapping) between PSFCH resources and PDSCHs (e.g., an association 330 described with reference to FIG. 3), where different groupcast transmissions may be transmitted over different PDSCHs. The association between PSFCH resources and PDSCHs may enable the UE 115-e and the UE 115-f to determine which groupcast transmission is indicated by the NACK and thus communicate a groupcast retransmission corresponding to the groupcast transmission. In some cases, the base station 105-b may transmit the retransmission indication in a MAC-CE. In some examples, the retransmission indication may be an example of an association message 255 described with reference to FIG. 2. In some examples, the base station 105-b may transmit the retransmission indication to the UE 115-e and the UE 115-f as a groupcast message.

At 415, the base station 105-b may transmit the groupcast transmission to the UE 115-e and the UE 115-f via the access link. That is, the base station 105-b may transmit (e.g., broadcast) a same groupcast message (e.g., the same downlink TBₖ) to each of the UE 115-e and the UE 115-f.

The UE 115-f may monitor the access link for the groupcast transmission from the base station 105-b and may fail to receive or decode the groupcast transmission. In response, at 420, the UE 115-f may transmit the NACK (e.g., the NACKⱼₖ) to the UE 115-e via the PSFCH resource in order to indicate to the UE 115-e that the UE 115-f failed to receive or decode the groupcast transmission. In some examples, the UE 115-f may broadcast the NACK to the group of UEs 115 via the PSFCH resource. In some examples, the UE 115-e may also transmit the NACK to the base station 105-b via the access link. The UE 115-f may transmit the NACK as part of a HARQ procedure. In some cases, the NACK may be an example of a NACK 225 described with reference to FIG. 2.

In some examples, the UE 115-f, the base station 105-b, or both, may perform one or more operations to deal with (e.g., resolve) a case in which no UEs 115 of the group of UEs 115 (e.g., the UE 115-e) meet a threshold for transmitting the groupcast retransmission (e.g., a measured threshold SINRₜₕ of the NACK). For example, the UE 115-f may transmit a NACK to base station 105-b and to the group of UEs 115. Based on or in response to receiving the NACK (e.g., the NACKⱼₖ) from UE 115-f, the base station 105-b may initiate a timer 425. If no UEs 115 in the group of UEs 115 satisfy the threshold for transmitting the groupcast retransmission, none of the UEs may transmit the groupcast retransmission and UE 115-f will not receive the groupcast retransmission. Accordingly, UE 115-f may not transmit an ACK (e.g., to base station 105-b) in this scenario because no groupcast retransmission was successfully received. If no ACK (e.g., an ACKⱼₖ) is received by base station 105-b from UE 115-f before the timer 425 elapses, the base station 105-b may be configured to automatically retransmit the groupcast transmission (e.g., the downlink TBₖ) to the UE 115-f. In other words, the timer 425 may run until the base station 105-b receives an ACK (e.g., the ACKⱼₖ) from the UE 115-f corresponding to the groupcast transmission or until the timer 425 expires. An expiration of the timer 425 may indicate for (e.g., trigger) the base station 105-b to transmit a groupcast retransmission to the UE 115-f that corresponds to the groupcast transmission. In some examples, base station 105-b may initiate timer 425 based on or in response to base station 105-b transmitting the groupcast transmission (e.g., at 415) rather than in response to receiving a NACK from UE 115-f (e.g., at 420). Accordingly, timer 425 may be initiated independent of receiving a NACK from UE 115-f in some examples.

Additionally, or alternatively, the UE 115-f may initiate a timer 430 after transmitting the NACK (e.g., the NACKⱼₖ) to the UE 115-e (e.g., and the base station 105-b). If no groupcast retransmission (e.g., the retransmission of the downlink TBₖ) is received or decoded successfully before the timer 430 elapses, the UE 115-f may transmit a second NACK (e.g., retransmit the NACKⱼₖ) to the base station 105-b over a PUCCH (e.g., at 465). In other words, the timer 430 may run until the UE 115-f successfully receives and decodes a groupcast retransmission corresponding to the groupcast transmission (e.g., the retransmission of the downlink TBₖ) or until the timer 430 expires. An expiration of the timer 430 may indicate for (e.g., trigger) the UE 115-f to transmit the second NACK (e.g., retransmit the NACKⱼₖ) to the base station 105-b (e.g., via a PUCCH) that indicates the failed reception of the groupcast transmission by the UE 115-f In some examples, a duration of the timer 430 may be configured via RRC signaling.

At 435, the base station 105-b may transmit the retransmission indication (e.g., described with reference to 410) to the UE 115-e and the UE 115-f, for example, via DCI. For example, the base station 105-b may be configured to transmit the retransmission indication to the UE 115-e and the UE 115-f via the DCI in response to receiving the NACK from the UE 115-f In some examples, the base station 105-b may be configured to transmit the retransmission indication either at 410 or at 435. For example, if, at 410, the base station 105-b transmits the retransmission indication, transmission of the retransmission indication at 435 may be unnecessary, and vice versa.

At 440, the UE 115-e may measure a channel metric corresponding to the NACK received from the UE 115-f. For example, the UE 115-e may measure an SINR of the NACK, an RSRP of the NACK, an RSRQ of the NACK, or a combination thereof. The UE 115-e may compare to the measured channel metric to a threshold (e.g., a threshold SINR, a threshold RSRP, a threshold RSRQ, a threshold corresponding to a combination of SINR, RSRP, or RSRQ) to determine whether to transmit the groupcast retransmission to the UE 115-f. For example, if the measured channel metric satisfies (e.g., is greater than, is greater than or equal to) the threshold, the UE 115-e may be configured to transmit the groupcast retransmission to the UE 115-f. Alternatively, if the measured channel metric fails to satisfy (e.g., is less than, is less than or equal to) the threshold, the UE 115-e may be configured to refrain from transmitting the groupcast retransmission to the UE 115-f. In the example of FIG. 4, the UE 115-e may determine that the measured channel metric satisfies the threshold based on the comparison and thus may determine to transmit the groupcast retransmission to the UE 115-f. Each UE within group of UEs 115 that receives the NACK may measure the channel metric, compare the measured channel metric to the threshold, and determine whether to transmit or refrain from transmitting the groupcast retransmission to the UE 115-f as described above with respect to UE 115-e.

At 445, the UE 115-e may transmit SCI to the UE 115-f (e.g., and the group of UEs 115) to preempt the PSSCH resource for transmission of the groupcast retransmission to the UE 115-f. For example, the SCI may reserve the PSSCH resource from a sidelink resource pool in accordance with a Mode 2 resource allocation mode.

At 450, the UE 115-e may transmit the groupcast retransmission to the UE 115-f. In some examples, the UE 115-e may transmit the groupcast retransmission using the PSSCH resource indicated by the retransmission indication (e.g., scheduled by the MAC-CE, scheduled by the DCI, indicated by the mapping between the PSFCH resource and the PSSCH resource). In some examples, the UE 115-e may transmit the groupcast retransmission using the PSSCH resource reserved by the SCI. In some cases, the UE 115-e may use the association between PSFCH resources and PDSCHs indicated by the retransmission indication to determine the groupcast transmission to which the groupcast retransmission corresponds.

The UE 115-f may monitor the PSSCH resource for the groupcast retransmission based on transmitting the NACK to the UE 115-e. If, at 450, the UE 115-f successfully receives and decodes the groupcast retransmission from the UE 115-e based on the monitoring, at 475, the UE 115-f may transmit an ACK to the UE 115-e and to the base station 105-b. The ACK may indicate that the UE 115-f successfully received and decoded the groupcast retransmission. In some examples, the base station 105-b may end (e.g., release) the HARQ procedure associated with the groupcast transmission in response to receiving the ACK from the UE 115-f.

Alternatively, if the UE 115-f fails to successfully receive or decode the groupcast retransmission at 450, at 455, the UE 115-e may be configured to transmit an additional NACK to the UE 115-e (e.g., via a second PSFCH resource indicated by the base station 105-b). At 460, the UE 115-e may transmit, in response to receiving the additional NACK, an additional groupcast retransmission to the UE 115-f via an additional PSSCH resource. If, at 460, the UE 115-f successfully receives and decodes the additional groupcast retransmission, at 475, the UE 115-f may transmit the ACK to the UE 115-e and the base station 105-b. Alternatively, in some cases, if the UE 115-f fails to successfully receive and decode the additional groupcast retransmission, the UE 115-e and the UE 115-f may repeat 455 and 460, for example, until the UE 115-f successfully receives and decodes a groupcast retransmission from the UE 115-e, the timer 430 expires, the UE 115-e and the UE 115-f perform 455 and 460 a threshold quantity of times (e.g., transmitting a threshold quantity of NACKs without successfully receiving and decoding a groupcast retransmission), or the UE 115-f receives the groupcast retransmission from the base station 105-b (e.g., at 470 after timer 425 expires).

At 465, the UE 115-f may transmit the second NACK to the base station 105-b via the access link (e.g., on a PUCCH). In some examples, the UE 115-f may transmit the second NACK in response to the timer 430 expiring. In some examples, the UE 115-f may transmit second NACK in response to transmitting the threshold quantity of NACKs without successfully receiving and decoding a groupcast retransmission from the UE 115-e. For example, the UE 115-f may set a maximum number of NACKⱼₖ retransmissions to be M, where M is some positive integer. If the UE 115-f does not receive a retransmission of the downlink TBₖ after sending the NACKⱼₖ M times, the UE 115-f may send the second NACKⱼₖ to the base station 105-a on a PUCCH.

At 470, the base station 105-b may transmit a groupcast retransmission corresponding to the groupcast transmission (e.g., retransmit the downlink TBₖ) to the UE 115-f. In some examples, the base station 105-b may transmit the groupcast retransmission in response to or based on receiving the second NACK (e.g., a retransmission of the NACKⱼₖ over a PUCCH) from the UE 115-f. In some examples, the base station 105-b may transmit the groupcast retransmission in response to or based on the timer 425 expiring.

Here, at 475, the UE 115-f may transmit the ACK to the UE 115-e and the base station 105-b in response to or based on successfully receiving and decoding the groupcast retransmission from the base station 105-b (e.g., at 470) or in response to or based on successfully receiving and decoding the groupcast retransmission from the UE 115-e (e.g., at 450 as described above).

By implementing the process flow 400, the base station 105-b, the UE 115-e, and the UE 115-f may support reduced power consumption, reduced latency, and increased resource usage efficiency associated with retransmitting groupcast transmissions, among other benefits. For example, the UE 115-e and the UE 115-f may be located relatively closer to each other as compared to the base station 105-b, and thus groupcast retransmissions may travel a shorter distance, thereby reducing latency and power consumption. Additionally, transmitting groupcast retransmissions via sidelink resources (e.g., from the UE 115-e to the UE 115-f) may reduce congestion of the access link between the base station 105-b and the UEs 115-e and 115-f, reduce usage of time and frequency resources of the access link, and reduce signaling overhead between the base station 105-b and the UEs 115-e and 115-f, thereby increasing resource usage efficiency and processing.

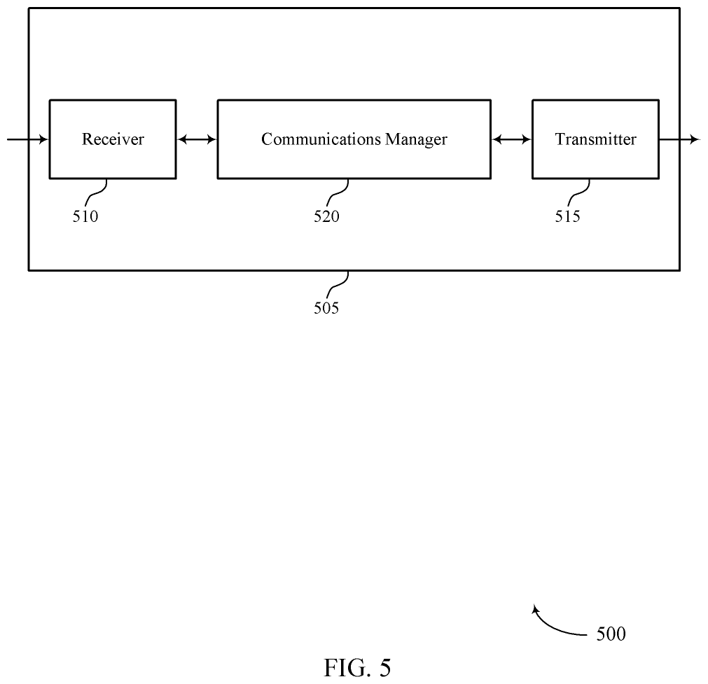

FIG. 5 shows a block diagram 500 of a device 505 that supports groupcast retransmission techniques in accordance with aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to groupcast retransmission techniques). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to groupcast retransmission techniques). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of groupcast retransmission techniques as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 520 may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communication at a first UE in accordance with examples as disclosed herein. For example, the communications manager 520 may be configured as or otherwise support a means for monitoring, from a base station via a communication link, for a groupcast transmission associated with a group of UEs including the first UE. The communications manager 520 may be configured as or otherwise support a means for transmitting, to a second UE of the group of UEs and via a sidelink feedback resource, a feedback message including a NACK that indicates a failed reception of the groupcast transmission by the first UE. The communications manager 520 may be configured as or otherwise support a means for monitoring, from the second UE via a sidelink resource, for a retransmission of the groupcast transmission based on transmitting the feedback message including the NACK.

Additionally or alternatively, the communications manager 520 may support wireless communication at a second UE in accordance with examples as disclosed herein. For example, the communications manager 520 may be configured as or otherwise support a means for receiving, from a base station via a communication link, a groupcast transmission associated with a group of UEs including a first UE and the second UE. The communications manager 520 may be configured as or otherwise support a means for receiving, from the first UE and via a sidelink feedback resource, a feedback message including a NACK that indicates a failed reception of the groupcast transmission by the first UE. The communications manager 520 may be configured as or otherwise support a means for transmitting, to the first UE via a sidelink resource, a retransmission of the groupcast transmission based on receiving the feedback message including the NACK.

By including or configuring the communications manager 520 in accordance with examples as described herein, the device 505 (e.g., a processor controlling or otherwise coupled to the receiver 510, the transmitter 515, the communications manager 520, or a combination thereof) may support techniques for reduced processing, reduced power consumption, more efficient utilization of communication resources by supporting the UE retransmission of groupcast transmissions over sidelink channels.

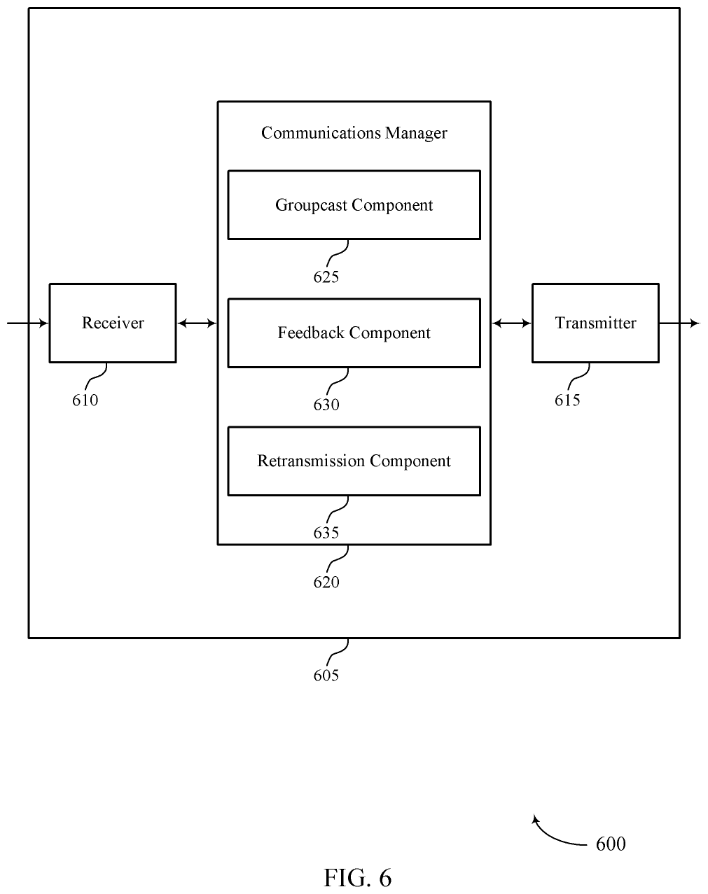

FIG. 6 shows a block diagram 600 of a device 605 that supports groupcast retransmission techniques in accordance with aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to groupcast retransmission techniques). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to groupcast retransmission techniques). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of groupcast retransmission techniques as described herein. For example, the communications manager 620 may include a groupcast component 625, a feedback component 630, a retransmission component 635, or any combination thereof. The communications manager 620 may be an example of aspects of a communications manager 520 as described herein. In some examples, the communications manager 620, or various components thereof, may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communication at a first UE in accordance with examples as disclosed herein. The groupcast component 625 may be configured as or otherwise support a means for monitoring, from a base station via a communication link, for a groupcast transmission associated with a group of UEs including the first UE. The feedback component 630 may be configured as or otherwise support a means for transmitting, to a second UE of the group of UEs and via a sidelink feedback resource, a feedback message including a NACK that indicates a failed reception of the groupcast transmission by the first UE. The retransmission component 635 may be configured as or otherwise support a means for monitoring, from the second UE via a sidelink resource, for a retransmission of the groupcast transmission based on transmitting the feedback message including the NACK.

Additionally or alternatively, the communications manager 620 may support wireless communication at a second UE in accordance with examples as disclosed herein. The groupcast component 625 may be configured as or otherwise support a means for receiving, from a base station via a communication link, a groupcast transmission associated with a group of UEs including a first UE and the second UE. The feedback component 630 may be configured as or otherwise support a means for receiving, from the first UE and via a sidelink feedback resource, a feedback message including a NACK that indicates a failed reception of the groupcast transmission by the first UE. The retransmission component 635 may be configured as or otherwise support a means for transmitting, to the first UE via a sidelink resource, a retransmission of the groupcast transmission based on receiving the feedback message including the NACK.

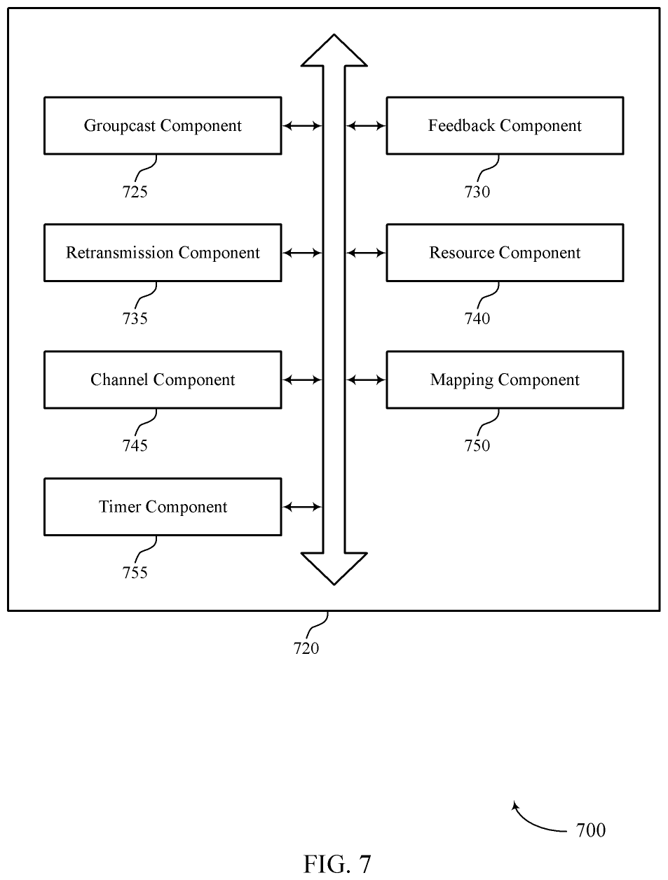

FIG. 7 shows a block diagram 700 of a communications manager 720 that supports groupcast retransmission techniques in accordance with aspects of the present disclosure. The communications manager 720 may be an example of aspects of a communications manager 520, a communications manager 620, or both, as described herein. The communications manager 720, or various components thereof, may be an example of means for performing various aspects of groupcast retransmission techniques as described herein. For example, the communications manager 720 may include a groupcast component 725, a feedback component 730, a retransmission component 735, a resource component 740, a channel component 745, a mapping component 750, a timer component 755, or any combination thereof. Each of these components may communicate, directly or indirectly, with one another (e.g., via one or more buses).

The communications manager 720 may support wireless communication at a first UE in accordance with examples as disclosed herein. The groupcast component 725 may be configured as or otherwise support a means for monitoring, from a base station via a communication link, for a groupcast transmission associated with a group of UEs including the first UE. The feedback component 730 may be configured as or otherwise support a means for transmitting, to a second UE of the group of UEs and via a sidelink feedback resource, a feedback message including a NACK that indicates a failed reception of the groupcast transmission by the first UE. The retransmission component 735 may be configured as or otherwise support a means for monitoring, from the second UE via a sidelink resource, for a retransmission of the groupcast transmission based on transmitting the feedback message including the NACK.

In some examples, the retransmission component 735 may be configured as or otherwise support a means for receiving, from the second UE via the sidelink resource, the retransmission of the groupcast transmission via the sidelink resource based on the monitoring. In some examples, the feedback component 730 may be configured as or otherwise support a means for transmitting, to at least one of the second UE via a second sidelink feedback resource or the base station via the communication link, a second feedback message including an ACK that indicates successful reception of the retransmission of the groupcast transmission by the first UE.

In some examples, the resource component 740 may be configured as or otherwise support a means for receiving, from the base station via the communication link, a message that indicates the sidelink feedback resource for the first UE to use to transmit the feedback message including the NACK.

In some examples, the message is received in DCI or RRC signaling.

In some examples, the resource component 740 may be configured as or otherwise support a means for receiving, from the base station via the communication link, a message that indicates the sidelink resource for the first UE to use to receive the retransmission of the groupcast transmission, where the sidelink resource is monitored by the first UE in response to or based on receiving the message that indicates the sidelink resource.

In some examples, the sidelink resource to monitor for the retransmission of the groupcast transmission is based on a mapping that maps the sidelink feedback resource to the sidelink resource.

In some examples, the resource component 740 may be configured as or otherwise support a means for receiving, from the second UE and based on transmitting the feedback message including the NACK, SCI that reserves the sidelink resource for the retransmission of the groupcast transmission, where the sidelink resource is monitored by the first UE based on receiving the SCI.

In some examples, the retransmission component 735 may be configured as or otherwise support a means for receiving, from the base station via the communication link, the retransmission of the groupcast transmission based on failing to successfully receive or decode the retransmission of the groupcast transmission from the second UE.

In some examples, the timer component 755 may be configured as or otherwise support a means for initiating a timer in response to or based on transmitting the feedback message including the NACK. In some examples, the feedback component 730 may be configured as or otherwise support a means for transmitting, to the base station via the communication link, a second feedback message including a second NACK that indicates the failed reception of the groupcast transmission by the first UE, the second feedback message transmitted in response to or based on an expiration of the timer, where the retransmission of the groupcast transmission is received from the base station in response to or based on transmitting the second feedback message.

In some examples, the feedback component 730 may be configured as or otherwise support a means for transmitting, to the second UE via respective sidelink feedback resources, a threshold quantity of feedback messages including respective NACKs that indicate the failed reception of the groupcast transmission by the first UE, the threshold quantity of feedback messages transmitted based on failing to successfully receive or decode the retransmission of the groupcast transmission from the second UE. In some examples, the feedback component 730 may be configured as or otherwise support a means for transmitting, to the base station via the communication link, a second feedback message including a second NACK that indicates the failed reception of the groupcast transmission by the first UE, the second feedback message transmitted in response to or based on transmitting the threshold quantity of feedback messages, where the retransmission of the groupcast transmission is received from the base station in response to or based on transmitting the second feedback message.

In some examples, the NACK includes an identifier associated with the first UE, a sequence number associated with the groupcast transmission, or both.

In some examples, the feedback component 730 may be configured as or otherwise support a means for transmitting, to the base station via the communication link, a second feedback message including the NACK that indicates the failed reception of the groupcast transmission by the first UE.

In some examples, to support transmitting the feedback message, the feedback component 730 may be configured as or otherwise support a means for broadcasting, over the sidelink feedback resource, the feedback message including the NACK to the group of UEs.

Additionally or alternatively, the communications manager 720 may support wireless communication at a second UE in accordance with examples as disclosed herein. In some examples, the groupcast component 725 may be configured as or otherwise support a means for receiving, from a base station via a communication link, a groupcast transmission associated with a group of UEs including a first UE and the second UE. In some examples, the feedback component 730 may be configured as or otherwise support a means for receiving, from the first UE and via a sidelink feedback resource, a feedback message including a NACK that indicates a failed reception of the groupcast transmission by the first UE. In some examples, the retransmission component 735 may be configured as or otherwise support a means for transmitting, to the first UE via a sidelink resource, a retransmission of the groupcast transmission based on receiving the feedback message including the NACK.

In some examples, the feedback component 730 may be configured as or otherwise support a means for receiving, from the first UE via a second sidelink feedback resource, a second feedback message including an ACK that indicates successful reception of the retransmission of the groupcast transmission by the first UE.

In some examples, the resource component 740 may be configured as or otherwise support a means for receiving, from the base station via the communication link, a message that indicates the sidelink feedback resource for the second UE to use to receive the feedback message including the NACK from the first UE.

In some examples, the resource component 740 may be configured as or otherwise support a means for receiving, from the base station via the communication link, a message that indicates the sidelink resource for the second UE to use to transmit the retransmission of the groupcast transmission.

In some examples, the sidelink resource to use to transmit the retransmission of the groupcast transmission is based on a mapping that maps the sidelink feedback resource to the sidelink resource.

In some examples, the resource component 740 may be configured as or otherwise support a means for transmitting, to the first UE and in response to or based on receiving the feedback message including the NACK, SCI that reserves the sidelink resource for the retransmission of the groupcast transmission.

In some examples, the channel component 745 may be configured as or otherwise support a means for measuring a channel metric associated with the feedback message including the NACK, where the retransmission of the groupcast transmission is transmitted based on the channel metric satisfying a threshold.

In some examples, the channel metric includes an SINR associated with the feedback message including the NACK, an RSRP associated with the feedback message including the NACK, an RSRQ associated with the feedback message including the NACK, or a combination thereof.

In some examples, the mapping component 750 may be configured as or otherwise support a means for receiving, from the base station via the communication link, a message that indicates an association between the sidelink feedback resource and the groupcast transmission. In some examples, the NACK indicates the failed reception of the groupcast transmission by the first UE based on at least one of the association between the sidelink resource and the groupcast transmission or an identifier associated with the first UE included in the NACK.

In some examples, the NACK indicates the failed reception of the groupcast transmission by the first UE based on at least one of an identifier associated with the first UE included in the NACK or a sequence number associated with the groupcast transmission included in the NACK.

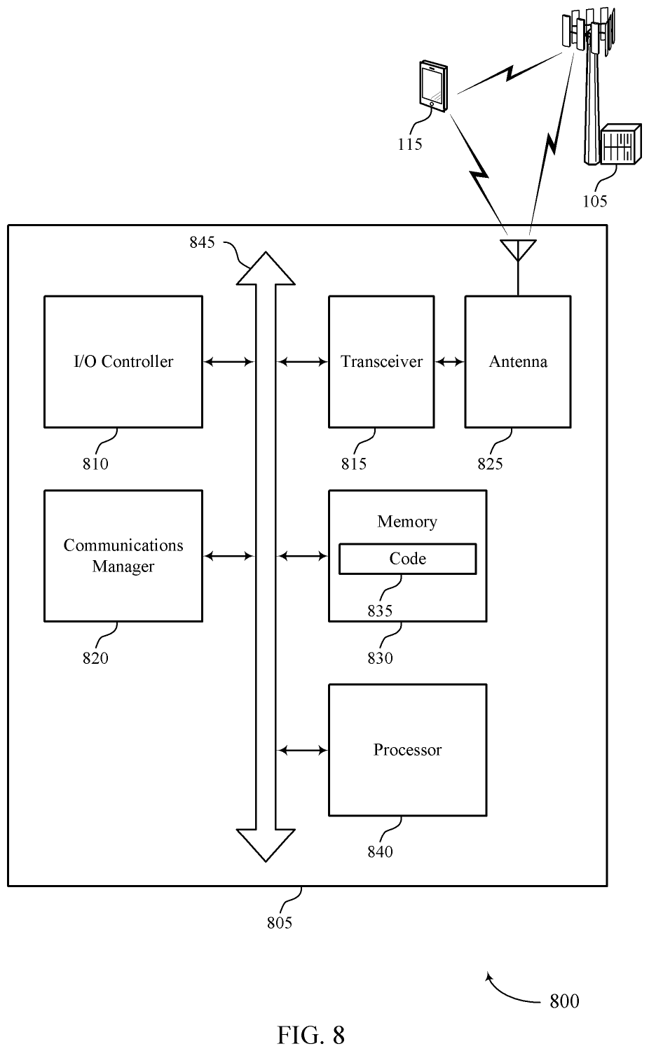

FIG. 8 shows a diagram of a system 800 including a device 805 that supports groupcast retransmission techniques in accordance with aspects of the present disclosure. The device 805 may be an example of or include the components of a device 505, a device 605, or a UE 115 as described herein. The device 805 may communicate wirelessly with one or more base stations 105, UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting groupcast retransmission techniques). For example, the device 805 or a component of the device 805 may include a processor 840 and memory 830 coupled to the processor 840, the processor 840 and memory 830 configured to perform various functions described herein.

The communications manager 820 may support wireless communication at a first UE in accordance with examples as disclosed herein. For example, the communications manager 820 may be configured as or otherwise support a means for monitoring, from a base station via a communication link, for a groupcast transmission associated with a group of UEs including the first UE. The communications manager 820 may be configured as or otherwise support a means for transmitting, to a second UE of the group of UEs and via a sidelink feedback resource, a feedback message including a NACK that indicates a failed reception of the groupcast transmission by the first UE. The communications manager 820 may be configured as or otherwise support a means for monitoring, from the second UE via a sidelink resource, for a retransmission of the groupcast transmission based on transmitting the feedback message including the NACK.

Additionally or alternatively, the communications manager 820 may support wireless communication at a second UE in accordance with examples as disclosed herein. For example, the communications manager 820 may be configured as or otherwise support a means for receiving, from a base station via a communication link, a groupcast transmission associated with a group of UEs including a first UE and the second UE. The communications manager 820 may be configured as or otherwise support a means for receiving, from the first UE and via a sidelink feedback resource, a feedback message including a NACK that indicates a failed reception of the groupcast transmission by the first UE. The communications manager 820 may be configured as or otherwise support a means for transmitting, to the first UE via a sidelink resource, a retransmission of the groupcast transmission based on receiving the feedback message including the NACK.

By including or configuring the communications manager 820 in accordance with examples as described herein, the device 805 may support techniques for reduced power consumption, reduced latency, increased data rates, improved spectral efficiency, more efficient utilization of communications resources, reduced communication link (e.g., access link) overhead, improved coordination between devices, longer battery life, and improved utilization of processing capability, among other benefits.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of groupcast retransmission techniques as described herein, or the processor 840 and the memory 830 may be otherwise configured to perform or support such operations.

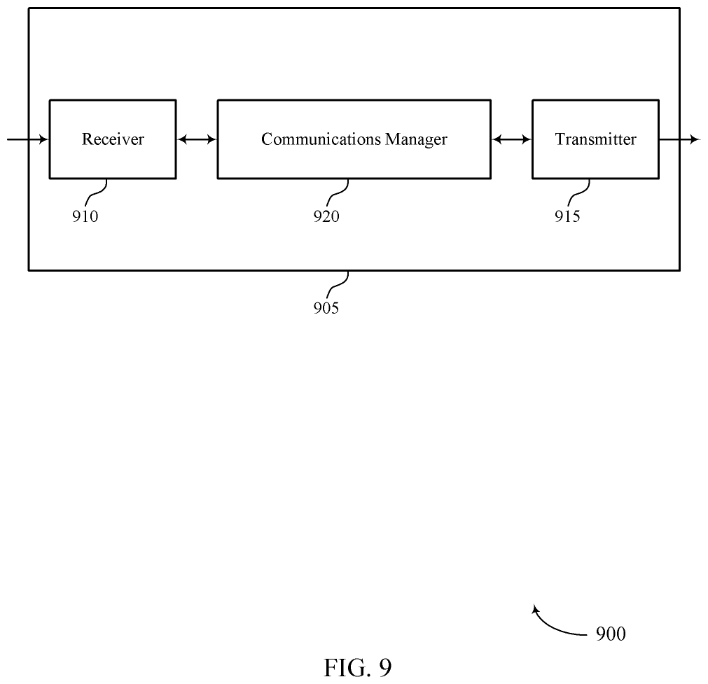

FIG. 9 shows a block diagram 900 of a device 905 that supports groupcast retransmission techniques in accordance with aspects of the present disclosure. The device 905 may be an example of aspects of a base station 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to groupcast retransmission techniques). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to groupcast retransmission techniques). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of groupcast retransmission techniques as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 920 may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communication at a base station in accordance with examples as disclosed herein. For example, the communications manager 920 may be configured as or otherwise support a means for transmitting, to a group of UEs via a communication link, a groupcast transmission associated with the group of UEs. The communications manager 920 may be configured as or otherwise support a means for transmitting, via the communication link, a message indicating a sidelink feedback resource for a UE of the group of UEs to use in transmitting a sidelink feedback message including a NACK that indicates failed reception of the groupcast transmission by the UE.

By including or configuring the communications manager 920 in accordance with examples as described herein, the device 905 (e.g., a processor controlling or otherwise coupled to the receiver 910, the transmitter 915, the communications manager 920, or a combination thereof) may support techniques for may support techniques for reduced processing, reduced power consumption, more efficient utilization of communication resources by enabling the UE retransmission of groupcast transmissions over sidelink channels.

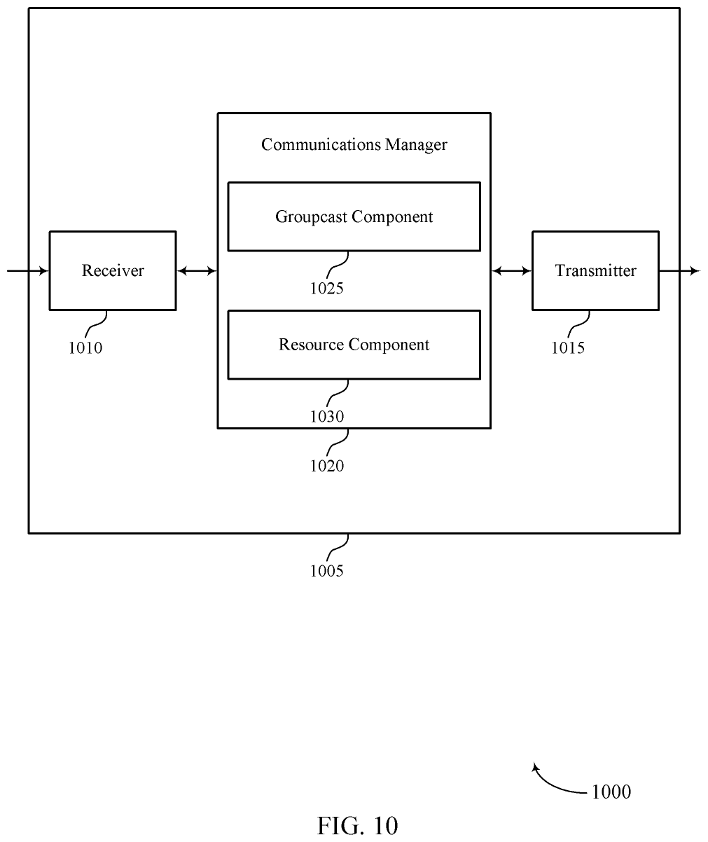

FIG. 10 shows a block diagram 1000 of a device 1005 that supports groupcast retransmission techniques in accordance with aspects of the present disclosure. The device 1005 may be an example of aspects of a device 905 or a base station 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to groupcast retransmission techniques). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to groupcast retransmission techniques). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of groupcast retransmission techniques as described herein. For example, the communications manager 1020 may include a groupcast component 1025 a resource component 1030, or any combination thereof. The communications manager 1020 may be an example of aspects of a communications manager 920 as described herein. In some examples, the communications manager 1020, or various components thereof, may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communication at a base station in accordance with examples as disclosed herein. The groupcast component 1025 may be configured as or otherwise support a means for transmitting, to a group of UEs via a communication link, a groupcast transmission associated with the group of UEs. The resource component 1030 may be configured as or otherwise support a means for transmitting, via the communication link, a message indicating a sidelink feedback resource for a UE of the group of UEs to use in transmitting a sidelink feedback message including a NACK that indicates failed reception of the groupcast transmission by the UE.

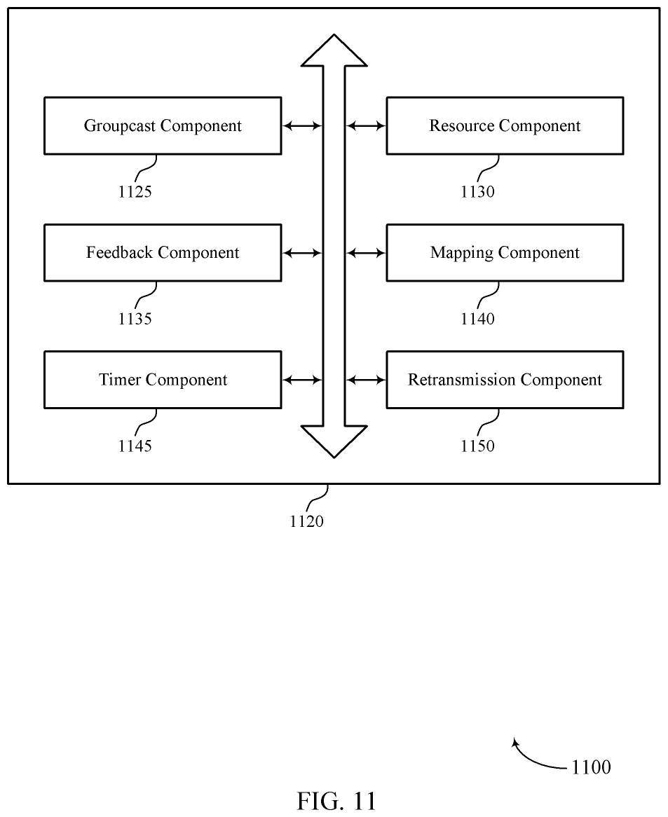

FIG. 11 shows a block diagram 1100 of a communications manager 1120 that supports groupcast retransmission techniques in accordance with aspects of the present disclosure. The communications manager 1120 may be an example of aspects of a communications manager 920, a communications manager 1020, or both, as described herein. The communications manager 1120, or various components thereof, may be an example of means for performing various aspects of groupcast retransmission techniques as described herein. For example, the communications manager 1120 may include a groupcast component 1125, a resource component 1130, a feedback component 1135, a mapping component 1140, a timer component 1145, a retransmission component 1150, or any combination thereof. Each of these components may communicate, directly or indirectly, with one another (e.g., via one or more buses).

The communications manager 1120 may support wireless communication at a base station in accordance with examples as disclosed herein. The groupcast component 1125 may be configured as or otherwise support a means for transmitting, to a group of UEs via a communication link, a groupcast transmission associated with the group of UEs. The resource component 1130 may be configured as or otherwise support a means for transmitting, via the communication link, a message indicating a sidelink feedback resource for a UE of the group of UEs to use in transmitting a sidelink feedback message including a NACK that indicates failed reception of the groupcast transmission by the UE.

In some examples, the feedback component 1135 may be configured as or otherwise support a means for receiving, from the UE via the communication link, a feedback message including the NACK that indicates the failed reception of the groupcast transmission by the UE.

In some examples, the timer component 1145 may be configured as or otherwise support a means for initiating a timer in response to or based on receiving the feedback message including the NACK. In some examples, the retransmission component 1150 may be configured as or otherwise support a means for transmitting, to the UE via the communication link, a retransmission of the groupcast transmission in response to or based on an expiration of the timer.

In some examples, the feedback component 1135 may be configured as or otherwise support a means for receiving, from the UE via the communication link, a second feedback message including a second NACK that indicates the failed reception of the groupcast transmission by the UE. In some examples, the retransmission component 1150 may be configured as or otherwise support a means for transmitting, to the UE via the communication link, a retransmission of the groupcast transmission in response to or based on receiving the second feedback message.

In some examples, the resource component 1130 may be configured as or otherwise support a means for transmitting, to the UE and a second UE of the group of UEs, a second message that indicates a sidelink resource for the second UE to use in transmitting a retransmission of the groupcast transmission to the UE.

In some examples, the mapping component 1140 may be configured as or otherwise support a means for transmitting, to the UE and a second UE of the group of UEs, a second message that indicates an association between the sidelink feedback resource and the groupcast transmission.

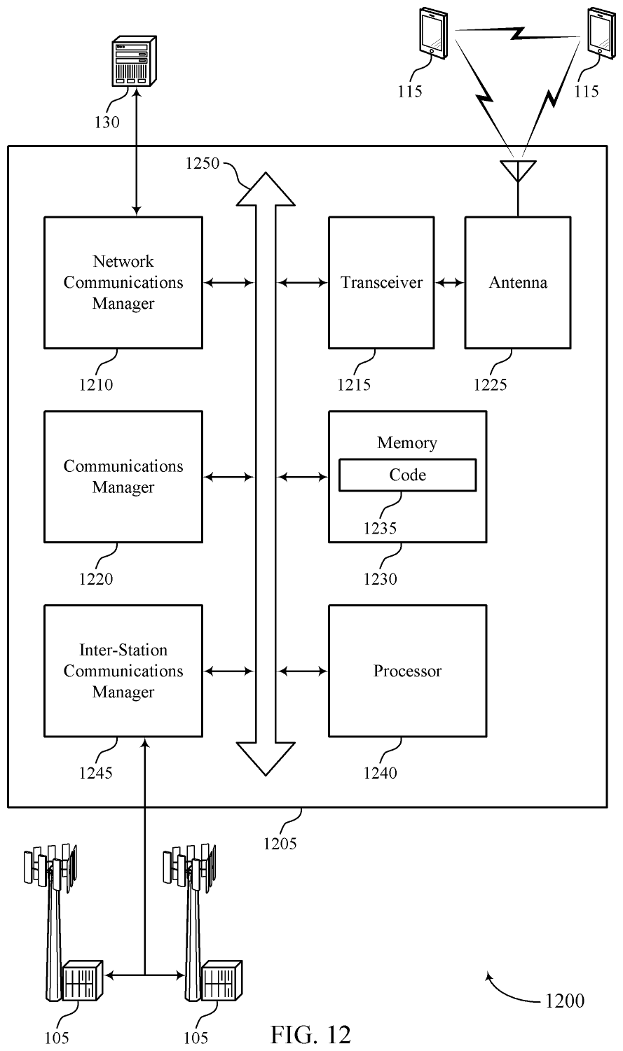

FIG. 12 shows a diagram of a system 1200 including a device 1205 that supports groupcast retransmission techniques in accordance with aspects of the present disclosure. The device 1205 may be an example of or include the components of a device 905, a device 1005, or a base station 105 as described herein. The device 1205 may communicate wirelessly with one or more base stations 105, UEs 115, or any combination thereof. The device 1205 may include components for bi-directional voice and data communications including components for transmitting and receiving communications, such as a communications manager 1220, a network communications manager 1210, a transceiver 1215, an antenna 1225, a memory 1230, code 1235, a processor 1240, and an inter-station communications manager 1245. These components may be in electronic communication or otherwise coupled (e.g., operatively, communicatively, functionally, electronically, electrically) via one or more buses (e.g., a bus 1250).

The network communications manager 1210 may manage communications with a core network 130 (e.g., via one or more wired backhaul links). For example, the network communications manager 1210 may manage the transfer of data communications for client devices, such as one or more UEs 115.

In some cases, the device 1205 may include a single antenna 1225. However, in some other cases the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include RAM and ROM. The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a BIOS which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting groupcast retransmission techniques). For example, the device 1205 or a component of the device 1205 may include a processor 1240 and memory 1230 coupled to the processor 1240, the processor 1240 and memory 1230 configured to perform various functions described herein.

The inter-station communications manager 1245 may manage communications with other base stations 105, and may include a controller or scheduler for controlling communications with UEs 115 in cooperation with other base stations 105. For example, the inter-station communications manager 1245 may coordinate scheduling for transmissions to UEs 115 for various interference mitigation techniques such as beamforming or joint transmission. In some examples, the inter-station communications manager 1245 may provide an X2 interface within an LTE/LTE-A wireless communications network technology to provide communication between base stations 105.

The communications manager 1220 may support wireless communication at a base station in accordance with examples as disclosed herein. For example, the communications manager 1220 may be configured as or otherwise support a means for transmitting, to a group of UEs via a communication link, a groupcast transmission associated with the group of UEs. The communications manager 1220 may be configured as or otherwise support a means for transmitting, via the communication link, a message indicating a sidelink feedback resource for a UE of the group of UEs to use in transmitting a sidelink feedback message including a NACK that indicates failed reception of the groupcast transmission by the UE.

By including or configuring the communications manager 1220 in accordance with examples as described herein, the device 1205 may support techniques for reduced power consumption, reduced latency, increased data rates, improved spectral efficiency, more efficient utilization of communications resources, reduced communication link (e.g., access link) overhead, improved coordination between devices, and improved utilization of processing capability, among other benefits.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of groupcast retransmission techniques as described herein, or the processor 1240 and the memory 1230 may be otherwise configured to perform or support such operations.

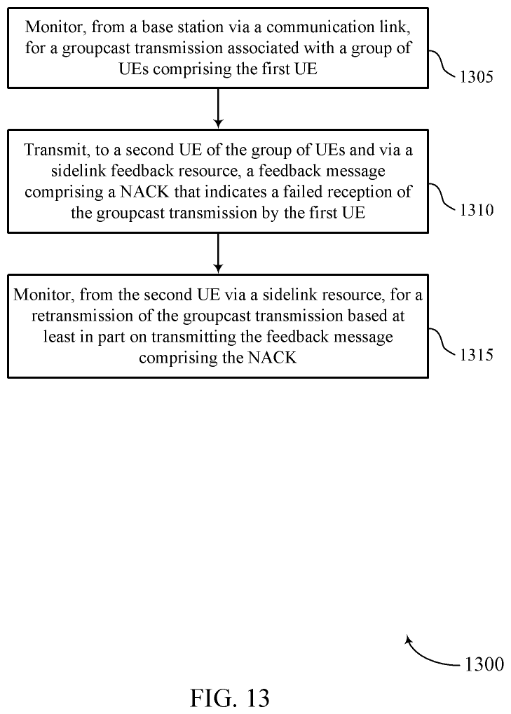

FIG. 13 shows a flowchart illustrating a method 1300 that supports groupcast retransmission techniques in accordance with aspects of the present disclosure. The operations of the method 1300 may be implemented by a first UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1305, the method may include monitoring, from a base station via a communication link, for a groupcast transmission associated with a group of UEs including the first UE. The operations of 1305 may be performed in accordance with examples as disclosed herein. In some examples, aspects of the operations of 1305 may be performed by a groupcast component 725 as described with reference to FIG. 7.

At 1310, the method may include transmitting, to a second UE of the group of UEs and via a sidelink feedback resource, a feedback message including a NACK that indicates a failed reception of the groupcast transmission by the first UE. The operations of 1310 may be performed in accordance with examples as disclosed herein. In some examples, aspects of the operations of 1310 may be performed by a feedback component 730 as described with reference to FIG. 7.

At 1315, the method may include monitoring, from the second UE via a sidelink resource, for a retransmission of the groupcast transmission based on transmitting the feedback message including the NACK. The operations of 1315 may be performed in accordance with examples as disclosed herein. In some examples, aspects of the operations of 1315 may be performed by a retransmission component 735 as described with reference to FIG. 7.

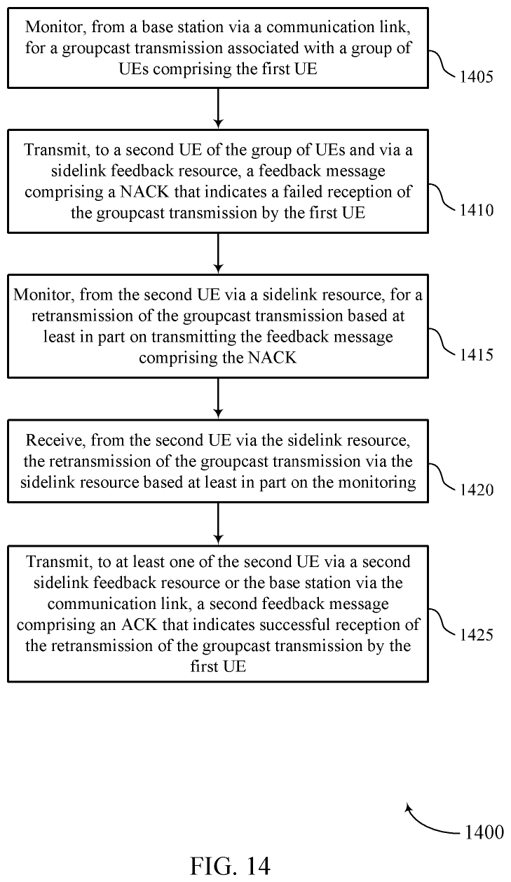

FIG. 14 shows a flowchart illustrating a method 1400 that supports groupcast retransmission techniques in accordance with aspects of the present disclosure. The operations of the method 1400 may be implemented by a first UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1405, the method may include monitoring, from a base station via a communication link, for a groupcast transmission associated with a group of UEs including the first UE. The operations of 1405 may be performed in accordance with examples as disclosed herein. In some examples, aspects of the operations of 1405 may be performed by a groupcast component 725 as described with reference to FIG. 7.

At 1410, the method may include transmitting, to a second UE of the group of UEs and via a sidelink feedback resource, a feedback message including a NACK that indicates a failed reception of the groupcast transmission by the first UE. The operations of 1410 may be performed in accordance with examples as disclosed herein. In some examples, aspects of the operations of 1410 may be performed by a feedback component 730 as described with reference to FIG. 7.

At 1415, the method may include monitoring, from the second UE via a sidelink resource, for a retransmission of the groupcast transmission in response to or based on transmitting the feedback message including the NACK. The operations of 1415 may be performed in accordance with examples as disclosed herein. In some examples, aspects of the operations of 1415 may be performed by a retransmission component 735 as described with reference to FIG. 7.

At 1420, the method may include receiving, from the second UE via the sidelink resource, the retransmission of the groupcast transmission via the sidelink resource based on the monitoring. The operations of 1420 may be performed in accordance with examples as disclosed herein. In some examples, aspects of the operations of 1420 may be performed by a retransmission component 735 as described with reference to FIG. 7.

At 1425, the method may include transmitting, to at least one of the second UE via a second sidelink feedback resource or the base station via the communication link, a second feedback message including an ACK that indicates successful reception of the retransmission of the groupcast transmission by the first UE. The operations of 1425 may be performed in accordance with examples as disclosed herein. In some examples, aspects of the operations of 1425 may be performed by a feedback component 730 as described with reference to FIG. 7.

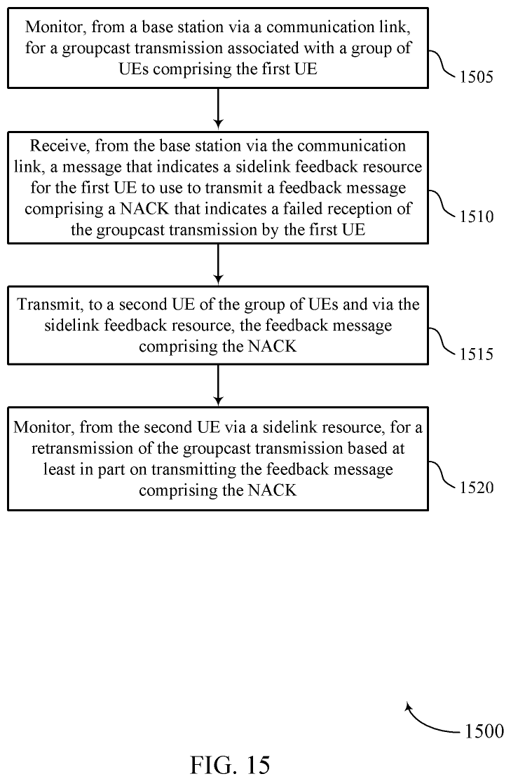

FIG. 15 shows a flowchart illustrating a method 1500 that supports groupcast retransmission techniques in accordance with aspects of the present disclosure. The operations of the method 1500 may be implemented by a first UE or its components as described herein. For example, the operations of the method 1500 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1505, the method may include monitoring, from a base station via a communication link, for a groupcast transmission associated with a group of UEs including the first UE. The operations of 1505 may be performed in accordance with examples as disclosed herein. In some examples, aspects of the operations of 1505 may be performed by a groupcast component 725 as described with reference to FIG. 7.

At 1510, the method may include receiving, from the base station via the communication link, a message that indicates a sidelink feedback resource for the first UE to use to transmit a feedback message including a NACK that indicates a failed reception of the groupcast transmission by the first UE. The operations of 1510 may be performed in accordance with examples as disclosed herein. In some examples, aspects of the operations of 1510 may be performed by a resource component 740 as described with reference to FIG. 7.

At 1515, the method may include transmitting, to a second UE of the group of UEs and via the sidelink feedback resource, the feedback message including the NACK. The operations of 1515 may be performed in accordance with examples as disclosed herein. In some examples, aspects of the operations of 1515 may be performed by a feedback component 730 as described with reference to FIG. 7.

At 1520, the method may include monitoring, from the second UE via a sidelink resource, for a retransmission of the groupcast transmission based on transmitting the feedback message including the NACK. The operations of 1520 may be performed in accordance with examples as disclosed herein. In some examples, aspects of the operations of 1520 may be performed by a retransmission component 735 as described with reference to FIG. 7.

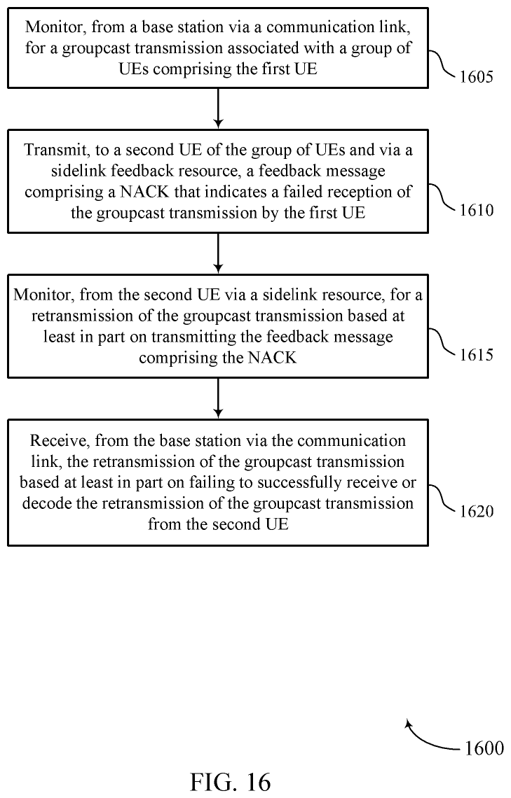

FIG. 16 shows a flowchart illustrating a method 1600 that supports groupcast retransmission techniques in accordance with aspects of the present disclosure. The operations of the method 1600 may be implemented by a first UE or its components as described herein. For example, the operations of the method 1600 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1605, the method may include monitoring, from a base station via a communication link, for a groupcast transmission associated with a group of UEs including the first UE. The operations of 1605 may be performed in accordance with examples as disclosed herein. In some examples, aspects of the operations of 1605 may be performed by a groupcast component 725 as described with reference to FIG. 7.

At 1610, the method may include transmitting, to a second UE of the group of UEs and via a sidelink feedback resource, a feedback message including a NACK that indicates a failed reception of the groupcast transmission by the first UE. The operations of 1610 may be performed in accordance with examples as disclosed herein. In some examples, aspects of the operations of 1610 may be performed by a feedback component 730 as described with reference to FIG. 7.

At 1615, the method may include monitoring, from the second UE via a sidelink resource, for a retransmission of the groupcast transmission based on transmitting the feedback message including the NACK. The operations of 1615 may be performed in accordance with examples as disclosed herein. In some examples, aspects of the operations of 1615 may be performed by a retransmission component 735 as described with reference to FIG. 7.

At 1620, the method may include receiving, from the base station via the communication link, the retransmission of the groupcast transmission based on failing to successfully receive or decode the retransmission of the groupcast transmission from the second UE. The operations of 1620 may be performed in accordance with examples as disclosed herein. In some examples, aspects of the operations of 1620 may be performed by a retransmission component 735 as described with reference to FIG. 7.

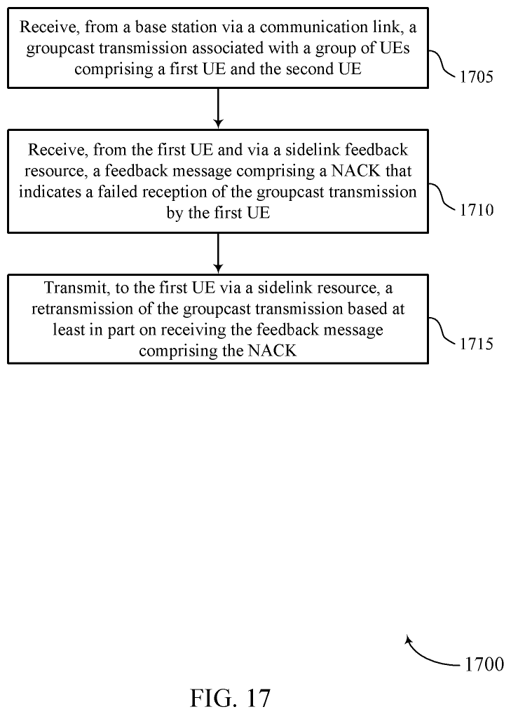

FIG. 17 shows a flowchart illustrating a method 1700 that supports groupcast retransmission techniques in accordance with aspects of the present disclosure. The operations of the method 1700 may be implemented by a second UE or its components as described herein. For example, the operations of the method 1700 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1705, the method may include receiving, from a base station via a communication link, a groupcast transmission associated with a group of UEs including a first UE and the second UE. The operations of 1705 may be performed in accordance with examples as disclosed herein. In some examples, aspects of the operations of 1705 may be performed by a groupcast component 725 as described with reference to FIG. 7.

At 1710, the method may include receiving, from the first UE and via a sidelink feedback resource, a feedback message including a NACK that indicates a failed reception of the groupcast transmission by the first UE. The operations of 1710 may be performed in accordance with examples as disclosed herein. In some examples, aspects of the operations of 1710 may be performed by a feedback component 730 as described with reference to FIG. 7.

At 1715, the method may include transmitting, to the first UE via a sidelink resource, a retransmission of the groupcast transmission based on receiving the feedback message including the NACK. The operations of 1715 may be performed in accordance with examples as disclosed herein. In some examples, aspects of the operations of 1715 may be performed by a retransmission component 735 as described with reference to FIG. 7.

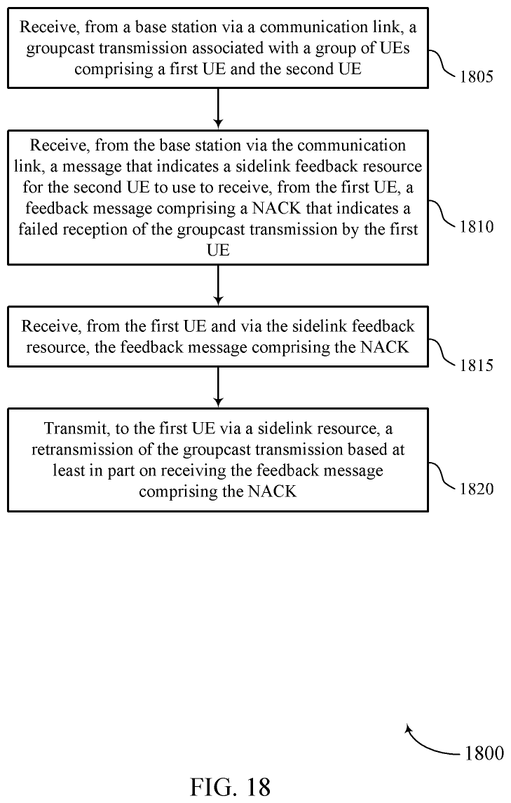

FIG. 18 shows a flowchart illustrating a method 1800 that supports groupcast retransmission techniques in accordance with aspects of the present disclosure. The operations of the method 1800 may be implemented by a UE or its components as described herein. For example, the operations of the method 1800 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1805, the method may include receiving, from a base station via a communication link, a groupcast transmission associated with a group of UEs including a first UE and the second UE. The operations of 1805 may be performed in accordance with examples as disclosed herein. In some examples, aspects of the operations of 1805 may be performed by a groupcast component 725 as described with reference to FIG. 7.

At 1810, the method may include receiving, from the base station via the communication link, a message that indicates a sidelink feedback resource for the second UE to use to receive, from the first UE, a feedback message including a NACK that indicates a failed reception of the groupcast transmission by the first UE. The operations of 1810 may be performed in accordance with examples as disclosed herein. In some examples, aspects of the operations of 1810 may be performed by a resource component 740 as described with reference to FIG. 7.

At 1815, the method may include receiving, from the first UE and via the sidelink feedback resource, the feedback message including the NACK. The operations of 1815 may be performed in accordance with examples as disclosed herein. In some examples, aspects of the operations of 1815 may be performed by a feedback component 730 as described with reference to FIG. 7.

At 1820, the method may include transmitting, to the first UE via a sidelink resource, a retransmission of the groupcast transmission based on receiving the feedback message including the NACK. The operations of 1820 may be performed in accordance with examples as disclosed herein. In some examples, aspects of the operations of 1820 may be performed by a retransmission component 735 as described with reference to FIG. 7.

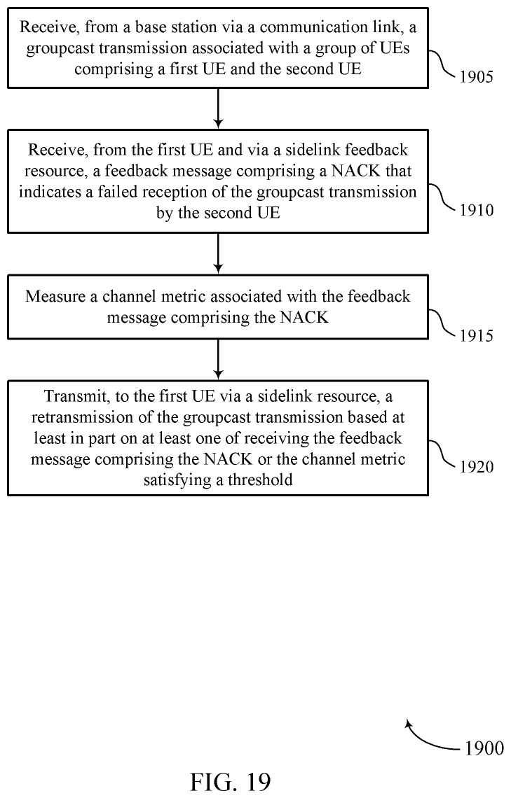

FIG. 19 shows a flowchart illustrating a method 1900 that supports groupcast retransmission techniques in accordance with aspects of the present disclosure. The operations of the method 1900 may be implemented by a second UE or its components as described herein. For example, the operations of the method 1900 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1905, the method may include receiving, from a base station via a communication link, a groupcast transmission associated with a group of UEs including a first UE and the second UE. The operations of 1905 may be performed in accordance with examples as disclosed herein. In some examples, aspects of the operations of 1905 may be performed by a groupcast component 725 as described with reference to FIG. 7.

At 1910, the method may include receiving, from the first UE and via a sidelink feedback resource, a feedback message including a NACK that indicates a failed reception of the groupcast transmission by the first UE. The operations of 1910 may be performed in accordance with examples as disclosed herein. In some examples, aspects of the operations of 1910 may be performed by a feedback component 730 as described with reference to FIG. 7.

At 1915, the method may include measuring a channel metric associated with the feedback message including the NACK. The operations of 1915 may be performed in accordance with examples as disclosed herein. In some examples, aspects of the operations of 1915 may be performed by a channel component 745 as described with reference to FIG. 7.

At 1920, the method may include transmitting, to the first UE via a sidelink resource, a retransmission of the groupcast transmission based on at least one of receiving the feedback message including the NACK or the channel metric satisfying the threshold. The operations of 1920 may be performed in accordance with examples as disclosed herein. In some examples, aspects of the operations of 1920 may be performed by a retransmission component 735 as described with reference to FIG. 7.

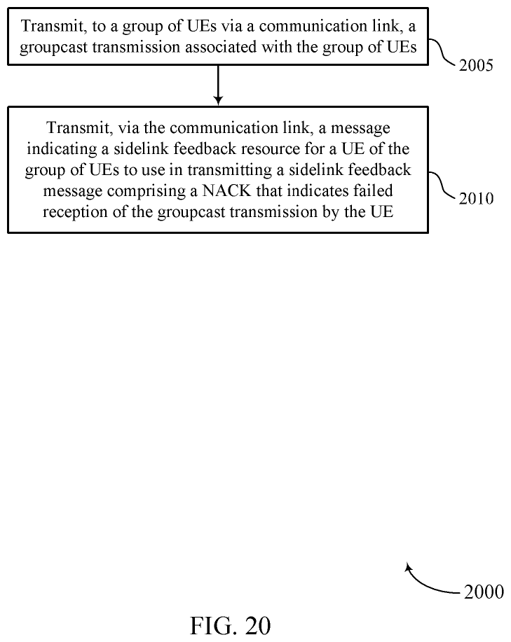

FIG. 20 shows a flowchart illustrating a method 2000 that supports groupcast retransmission techniques in accordance with aspects of the present disclosure. The operations of the method 2000 may be implemented by a base station or its components as described herein. For example, the operations of the method 2000 may be performed by a base station 105 as described with reference to FIGS. 1 through 4 and 9 through 12. In some examples, a base station may execute a set of instructions to control the functional elements of the base station to perform the described functions. Additionally or alternatively, the base station may perform aspects of the described functions using special-purpose hardware.

At 2005, the method may include transmitting, to a group of UEs via a communication link, a groupcast transmission associated with the group of UEs. The operations of 2005 may be performed in accordance with examples as disclosed herein. In some examples, aspects of the operations of 2005 may be performed by a groupcast component 1125 as described with reference to FIG. 11.

At 2010, the method may include transmitting, via the communication link, a message indicating a sidelink feedback resource for a UE of the group of UEs to use in transmitting a sidelink feedback message including a NACK that indicates failed reception of the groupcast transmission by the UE. The operations of 2010 may be performed in accordance with examples as disclosed herein. In some examples, aspects of the operations of 2010 may be performed by a resource component 1130 as described with reference to FIG. 11.

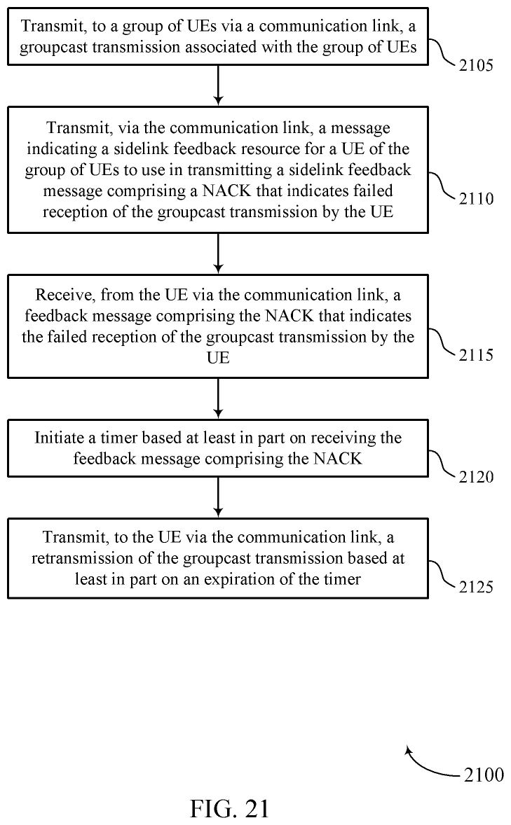

FIG. 21 shows a flowchart illustrating a method 2100 that supports groupcast retransmission techniques in accordance with aspects of the present disclosure. The operations of the method 2100 may be implemented by a base station or its components as described herein. For example, the operations of the method 2100 may be performed by a base station 105 as described with reference to FIGS. 1 through 4 and 9 through 12. In some examples, a base station may execute a set of instructions to control the functional elements of the base station to perform the described functions. Additionally or alternatively, the base station may perform aspects of the described functions using special-purpose hardware.

At 2105, the method may include transmitting, to a group of UEs via a communication link, a groupcast transmission associated with the group of UEs. The operations of 2105 may be performed in accordance with examples as disclosed herein. In some examples, aspects of the operations of 2105 may be performed by a groupcast component 1125 as described with reference to FIG. 11.

At 2110, the method may include transmitting, via the communication link, a message indicating a sidelink feedback resource for a UE of the group of UEs to use in transmitting a sidelink feedback message including a NACK that indicates failed reception of the groupcast transmission by the UE. The operations of 2110 may be performed in accordance with examples as disclosed herein. In some examples, aspects of the operations of 2110 may be performed by a resource component 1130 as described with reference to FIG. 11.

At 2115, the method may include receiving, from the UE via the communication link, a feedback message including the NACK that indicates the failed reception of the groupcast transmission by the UE. The operations of 2115 may be performed in accordance with examples as disclosed herein. In some examples, aspects of the operations of 2115 may be performed by a feedback component 1135 as described with reference to FIG. 11.

At 2120, the method may include initiating a timer in response to or based on receiving the feedback message including the NACK. The operations of 2120 may be performed in accordance with examples as disclosed herein. In some examples, aspects of the operations of 2120 may be performed by a timer component 1145 as described with reference to FIG. 11.

At 2125, the method may include transmitting, to the UE via the communication link, a retransmission of the groupcast transmission in response to or based on an expiration of the timer. The operations of 2125 may be performed in accordance with examples as disclosed herein. In some examples, aspects of the operations of 2125 may be performed by a retransmission component 1150 as described with reference to FIG. 11.

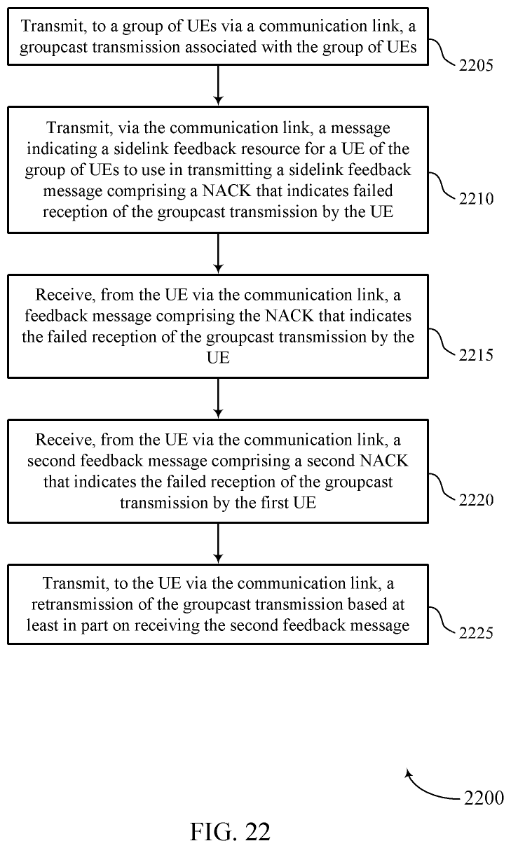

FIG. 22 shows a flowchart illustrating a method 2200 that supports groupcast retransmission techniques in accordance with aspects of the present disclosure. The operations of the method 2200 may be implemented by a base station or its components as described herein. For example, the operations of the method 2200 may be performed by a base station 105 as described with reference to FIGS. 1 through 4 and 9 through 12. In some examples, a base station may execute a set of instructions to control the functional elements of the base station to perform the described functions. Additionally or alternatively, the base station may perform aspects of the described functions using special-purpose hardware.

At 2205, the method may include transmitting, to a group of UEs via a communication link, a groupcast transmission associated with the group of UEs. The operations of 2205 may be performed in accordance with examples as disclosed herein. In some examples, aspects of the operations of 2205 may be performed by a groupcast component 1125 as described with reference to FIG. 11.

At 2210, the method may include transmitting, via the communication link, a message indicating a sidelink feedback resource for a UE of the group of UEs to use in transmitting a sidelink feedback message including a NACK that indicates failed reception of the groupcast transmission by the UE. The operations of 2210 may be performed in accordance with examples as disclosed herein. In some examples, aspects of the operations of 2210 may be performed by a resource component 1130 as described with reference to FIG. 11.

At 2215, the method may include receiving, from the UE via the communication link, a feedback message including the NACK that indicates the failed reception of the groupcast transmission by the UE. The operations of 2215 may be performed in accordance with examples as disclosed herein. In some examples, aspects of the operations of 2215 may be performed by a feedback component 1135 as described with reference to FIG. 11.

At 2220, the method may include receiving, from the UE via the communication link, a second feedback message including a second NACK that indicates the failed reception of the groupcast transmission by the UE. The operations of 2220 may be performed in accordance with examples as disclosed herein. In some examples, aspects of the operations of 2220 may be performed by a feedback component 1135 as described with reference to FIG. 11.

At 2225, the method may include transmitting, to the UE via the communication link, a retransmission of the groupcast transmission in response to or based on receiving the second feedback message. The operations of 2225 may be performed in accordance with examples as disclosed herein. In some examples, aspects of the operations of 2225 may be performed by a retransmission component 1150 as described with reference to FIG. 11.

The following provides an overview of aspects of the present disclosure:

Aspect 1: A method for wireless communication at a first UE, comprising: monitoring, from a base station via a communication link, for a groupcast transmission associated with a group of UEs comprising the first UE; transmitting, to a second UE of the group of UEs and via a sidelink feedback resource, a feedback message comprising a NACK that indicates a failed reception of the groupcast transmission by the first UE; and monitoring, from the second UE via a sidelink resource, for a retransmission of the groupcast transmission based at least in part on transmitting the feedback message comprising the NACK.

Aspect 2: The method of aspect 1, further comprising: receiving, from the second UE via the sidelink resource, the retransmission of the groupcast transmission via the sidelink resource based at least in part on the monitoring; and transmitting, to at least one of the second UE via a second sidelink feedback resource or the base station via the communication link, a second feedback message comprising an ACK that indicates successful reception of the retransmission of the groupcast transmission by the first UE.

Aspect 3: The method of any of aspects 1 through 2, further comprising: receiving, from the base station via the communication link, a message that indicates the sidelink feedback resource for the first UE to use to transmit the feedback message comprising the NACK.

Aspect 4: The method of aspect 3, wherein the message is received in DCI or RRC signaling.

Aspect 5: The method of any of aspects 1 through 4, further comprising: receiving, from the base station via the communication link, a message that indicates the sidelink resource for the first UE to use to receive the retransmission of the groupcast transmission, wherein the sidelink resource is monitored by the first UE based at least in part on receiving the message that indicates the sidelink resource.

Aspect 6: The method of any of aspects 1 through 4, wherein the sidelink resource to monitor for the retransmission of the groupcast transmission is based at least in part on a mapping that maps the sidelink feedback resource to the sidelink resource

Aspect 7: The method of any of aspects 1 through 4, further comprising: receive, from the second UE and based at least in part on transmitting the feedback message comprising the NACK, SCI that reserves the sidelink resource for the retransmission of the groupcast transmission, wherein the sidelink resource is monitored by the first UE based at least in part on receiving the SCI.

Aspect 8: The method of any of aspects 1 and 3 through 7, further comprising: receiving, from the base station via the communication link, the retransmission of the groupcast transmission based at least in part on failing to successfully receive or decode the retransmission of the groupcast transmission from the second UE.

Aspect 9: The method of aspect 8, further comprising: initiating a timer based at least in part on transmitting the feedback message comprising the NACK; and transmitting, to the base station via the communication link, a second feedback message comprising a second NACK that indicates the failed reception of the groupcast transmission by the first UE, the second feedback message transmitted based at least in part on an expiration of the timer, wherein the retransmission of the groupcast transmission is received from the base station based at least in part on transmitting the second feedback message.

Aspect 10: The method of aspect 8, further comprising: transmitting, to the second UE via respective sidelink feedback resources, a threshold quantity of feedback messages comprising respective NACKs that indicate the failed reception of the groupcast transmission by the first UE, the threshold quantity of feedback messages transmitted based at least in part on failing to successfully receive or decode the retransmission of the groupcast transmission from the second UE; and transmitting, to the base station via the communication link, a second feedback message comprising a second NACK that indicates the failed reception of the groupcast transmission by the first UE, the second feedback message transmitted based at least in part on transmitting the threshold quantity of feedback messages, wherein the retransmission of the groupcast transmission is received from the base station based at least in part on transmitting the second feedback message.

Aspect 11: The method of any of aspects 1 through 10, wherein the NACK comprises an identifier associated with the first UE, a sequence number associated with the groupcast transmission, or both.

Aspect 12: The method of any of aspects 1 through 11, further comprising: transmitting, to the base station via the communication link, a second feedback message comprising the NACK that indicates the failed reception of the groupcast transmission by the first UE.

Aspect 13: The method of any of aspects 1 through 12, wherein transmitting the feedback message comprises: broadcasting, over the sidelink feedback resource, the feedback message comprising the NACK to the group of UEs.

Aspect 14: A method for wireless communication at a second UE, comprising: receiving, from a base station via a communication link, a groupcast transmission associated with a group of UEs comprising the second UE; receiving, from a first UE of the group of UEs and via a sidelink feedback resource, a feedback message comprising a NACK that indicates a failed reception of the groupcast transmission by the first UE; and transmitting, to the first UE via a sidelink resource, a retransmission of the groupcast transmission based at least in part on receiving the feedback message comprising the NACK.

Aspect 15: The method of aspect 14, further comprising: receiving, from the first UE via a second sidelink feedback resource, a second feedback message comprising an ACK that indicates successful reception of the retransmission of the groupcast transmission by the first UE.

Aspect 16: The method of any of aspects 14 through 15, further comprising: receiving, from the base station via the communication link, a message that indicates the sidelink feedback resource for the second UE to use to receive the feedback message comprising the NACK from the first UE.

Aspect 17: The method of any of aspects 14 through 16, further comprising: receiving, from the base station via the communication link, a message that indicates the sidelink resource for the second UE to use to transmit the retransmission of the groupcast transmission.

Aspect 18: The method of any of aspects 14 through 16, wherein the sidelink resource to use to transmit the retransmission of the groupcast transmission is based at least in part on a mapping that maps the sidelink feedback resource to the sidelink resource.

Aspect 19: The method of any of aspects 14 through 16, further comprising: transmitting, to the first UE and based at least in part on receiving the feedback message comprising the NACK, SCI that reserves the sidelink resource for the retransmission of the groupcast transmission.

Aspect 20: The method of any of aspects 14 through 19, further comprising: measuring a channel metric associated with the feedback message comprising the NACK, wherein the retransmission of the groupcast transmission is transmitted based at least in part on the channel metric satisfying a threshold.

Aspect 21: The method of aspect 20, wherein the channel metric comprises an SINR associated with the feedback message comprising the NACK, an RSRP associated with the feedback message comprising the NACK, an RSRQ associated with the feedback message comprising the NACK, or a combination thereof.

Aspect 22: The method of any of aspects 14 through 21, further comprising: receive, from the base station via the communication link, a message that indicates an association between the sidelink feedback resource and the groupcast transmission, wherein the NACK indicates the failed reception of the groupcast transmission by the first UE based at least in part on at least one of the association between the sidelink resource and the groupcast transmission or an identifier associated with the first UE included in the NACK.

Aspect 23: The method of any of aspects 14 through 22, wherein the NACK indicates the failed reception of the groupcast transmission by the first UE based at least in part on at least one of an identifier associated with the first UE included in the NACK or a sequence number associated with the groupcast transmission included in the NACK

Aspect 24: A method for wireless communication at a base station, comprising: transmitting, to a group of UEs via a communication link, a groupcast transmission associated with the group of UEs; transmitting, via the communication link, a message indicating a sidelink feedback resource for a UE of the group of UEs to use in transmitting a sidelink feedback message comprising a NACK that indicates failed reception of the groupcast transmission by the UE.

Aspect 25: The method of aspect 24, further comprising: receiving, from the UE via the communication link, a feedback message comprising the NACK that indicates the failed reception of the groupcast transmission by the UE.

Aspect 26: The method of aspect 25, further comprising: initiating a timer based at least in part on receiving the feedback message comprising the NACK; transmitting, to the UE via the communication link, a retransmission of the groupcast transmission based at least in part on an expiration of the timer.

Aspect 27: The method of any of aspects 25 through 26, further comprising: receiving, from the UE via the communication link, a second feedback message comprising a second NACK that indicates the failed reception of the groupcast transmission by the first UE; and transmitting, to the UE via the communication link, a retransmission of the groupcast transmission based at least in part on receiving the second feedback message.

Aspect 28: The method of any of aspects 24 through 27, further comprising: transmitting, to the UE and a second UE of the group of UEs, a second message that indicates a sidelink resource for the second UE to use in transmitting a retransmission of the groupcast transmission to the UE.

Aspect 29: The method of any of aspects 24 through 28, further comprising: transmitting, a second UE of the group of UEs, a second message that indicates an association between the sidelink feedback resource and the groupcast transmission.

Aspect 30: An apparatus for wireless communication at a first UE, comprising a processor; memory coupled with the processor; and instructions stored in the memory and executable by the processor to cause the apparatus to perform a method of any of aspects 1 through 13.

Aspect 31: An apparatus for wireless communication at a first UE, comprising at least one means for performing a method of any of aspects 1 through 13.

Aspect 32: A non-transitory computer-readable medium storing code for wireless communication at a first UE, the code comprising instructions executable by a processor to perform a method of any of aspects 1 through 13.

Aspect 33: An apparatus for wireless communication at a second UE, comprising a processor; memory coupled with the processor; and instructions stored in the memory and executable by the processor to cause the apparatus to perform a method of any of aspects 14 through 23.

Aspect 34: An apparatus for wireless communication at a second UE, comprising at least one means for performing a method of any of aspects 14 through 23.

Aspect 35: A non-transitory computer-readable medium storing code for wireless communication at a second UE, the code comprising instructions executable by a processor to perform a method of any of aspects 14 through 23.

Aspect 36: An apparatus for wireless communication at a base station, comprising a processor; memory coupled with the processor; and instructions stored in the memory and executable by the processor to cause the apparatus to perform a method of any of aspects 24 through 29.

Aspect 37: An apparatus for wireless communication at a base station, comprising at least one means for performing a method of any of aspects 24 through 29.

Aspect 38: A non-transitory computer-readable medium storing code for wireless communication at a base station, the code comprising instructions executable by a processor to perform a method of any of aspects 24 through 29.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a first user equipment (UE), comprising:
a processor;
memory coupled with the processor; and
instructions stored in the memory and executable by the processor to cause the apparatus to:
monitor, from a base station via a communication link, for a groupcast transmission associated with a group of UEs comprising the first UE;
transmit, to a second UE of the group of UEs and via a sidelink feedback resource, a feedback message comprising a negative acknowledgement that indicates a failed reception of the groupcast transmission by the first UE; and
monitor, from the second UE via a sidelink resource, for a retransmission of the groupcast transmission based at least in part on transmitting the feedback message comprising the negative acknowledgement.

2. The apparatus of claim 1, wherein the instructions are further executable by the processor to cause the apparatus to:
receive, from the second UE via the sidelink resource, the retransmission of the groupcast transmission via the sidelink resource based at least in part on the monitoring; and
transmit, to at least one of the second UE via a second sidelink feedback resource or the base station via the communication link, a second feedback message comprising an acknowledgement that indicates successful reception of the retransmission of the groupcast transmission by the first UE.

3. The apparatus of claim 1, wherein the instructions are further executable by the processor to cause the apparatus to:
receive, from the base station via the communication link, a message that indicates the sidelink feedback resource for the first UE to use to transmit the feedback message comprising the negative acknowledgement.

4. The apparatus of claim 3, wherein the message is received in downlink control information or radio resource control signaling.

5. The apparatus of claim 1, wherein the instructions are further executable by the processor to cause the apparatus to:
receive, from the base station via the communication link, a message that indicates the sidelink resource for the first UE to use to receive the retransmission of the groupcast transmission,
wherein the sidelink resource is monitored by the first UE based at least in part on receiving the message that indicates the sidelink resource.

6. The apparatus of claim 1, wherein the sidelink resource to monitor for the retransmission of the groupcast transmission is based at least in part on a mapping that maps the sidelink feedback resource to the sidelink resource.

7. The apparatus of claim 1, wherein the instructions are further executable by the processor to cause the apparatus to:
receive, from the second UE and based at least in part on transmitting the feedback message comprising the negative acknowledgement, sidelink control information that reserves the sidelink resource for the retransmission of the groupcast transmission,
wherein the sidelink resource is monitored by the first UE based at least in part on receiving the sidelink control information.

8. The apparatus of claim 1, wherein the instructions are further executable by the processor to cause the apparatus to:
receive, from the base station via the communication link, the retransmission of the groupcast transmission based at least in part on failing to successfully receive or decode the retransmission of the groupcast transmission from the second UE.

9. The apparatus of claim 8, wherein the instructions are further executable by the processor to cause the apparatus to:
initiate a timer based at least in part on transmitting the feedback message comprising the negative acknowledgement; and
transmit, to the base station via the communication link, a second feedback message comprising a second negative acknowledgement that indicates the failed reception of the groupcast transmission by the first UE, the second feedback message transmitted based at least in part on an expiration of the timer,
wherein the retransmission of the groupcast transmission is received from the base station based at least in part on transmitting the second feedback message.

10. The apparatus of claim 8, wherein the instructions are further executable by the processor to cause the apparatus to:
transmit, to the second UE via respective sidelink feedback resources, a threshold quantity of feedback messages comprising respective negative acknowledgements that indicate the failed reception of the groupcast transmission by the first UE, the threshold quantity of feedback messages transmitted based at least in part on failing to successfully receive or decode the retransmission of the groupcast transmission from the second UE; and
transmit, to the base station via the communication link, a second feedback message comprising a second negative acknowledgement that indicates the failed reception of the groupcast transmission by the first UE, the second feedback message transmitted based at least in part on transmitting the threshold quantity of feedback messages,
wherein the retransmission of the groupcast transmission is received from the base station based at least in part on transmitting the second feedback message.

11. The apparatus of claim 1, wherein the negative acknowledgement comprises an identifier associated with the first UE, a sequence number associated with the groupcast transmission, or both.

12. The apparatus of claim 1, wherein the instructions are further executable by the processor to cause the apparatus to:
transmit, to the base station via the communication link, a second feedback message comprising the negative acknowledgement that indicates the failed reception of the groupcast transmission by the first UE.

13. The apparatus of claim 1, wherein the instructions to transmit the feedback message are further executable by the processor to cause the apparatus to:
broadcast, over the sidelink feedback resource, the feedback message comprise the negative acknowledgement to the group of UEs.

14. An apparatus for wireless communication at a second user equipment (UE), comprising:
a processor;
memory coupled with the processor; and
instructions stored in the memory and executable by the processor to cause the apparatus to:
receive, from a base station via a communication link, a groupcast transmission associated with a group of UEs comprising a first UE and the second UE;
receive, from the first UE and via a sidelink feedback resource, a feedback message comprising a negative acknowledgement that indicates a failed reception of the groupcast transmission by the first UE; and
transmit, to the first UE via a sidelink resource, a retransmission of the groupcast transmission based at least in part on receiving the feedback message comprising the negative acknowledgement.

15. The apparatus of claim 14, wherein the instructions are further executable by the processor to cause the apparatus to:
receive, from the first UE via a second sidelink feedback resource, a second feedback message comprising an acknowledgement that indicates successful reception of the retransmission of the groupcast transmission by the first UE.

16. The apparatus of claim 14, wherein the instructions are further executable by the processor to cause the apparatus to:
receive, from the base station via the communication link, a message that indicates the sidelink feedback resource for the second UE to use to receive the feedback message comprising the negative acknowledgement from the first UE.

17. The apparatus of claim 14, wherein the instructions are further executable by the processor to cause the apparatus to:
receive, from the base station via the communication link, a message that indicates the sidelink resource for the second UE to use to transmit the retransmission of the groupcast transmission.

18. The apparatus of claim 14, wherein the sidelink resource to use to transmit the retransmission of the groupcast transmission is based at least in part on a mapping that maps the sidelink feedback resource to the sidelink resource.

19. The apparatus of claim 14, wherein the instructions are further executable by the processor to cause the apparatus to:
transmit, to the first UE and based at least in part on receiving the feedback message comprising the negative acknowledgement, sidelink control information that reserves the sidelink resource for the retransmission of the groupcast transmission.

20. The apparatus of claim 14, wherein the instructions are further executable by the processor to cause the apparatus to:
measure a channel metric associated with the feedback message comprising the negative acknowledgement,
wherein the retransmission of the groupcast transmission is transmitted based at least in part on the channel metric satisfying a threshold.

21. The apparatus of claim 20, wherein the channel metric comprises a signal-to-interference-plus-noise ratio associated with the feedback message comprising the negative acknowledgement, a reference signal received power associated with the feedback message comprising the negative acknowledgement, a reference signal received quality associated with the feedback message comprising the negative acknowledgement, or a combination thereof.

22. The apparatus of claim 14, wherein the instructions are further executable by the processor to cause the apparatus to:
receive, from the base station via the communication link, a message that indicates an association between the sidelink feedback resource and the groupcast transmission,
wherein the negative acknowledgement indicates the failed reception of the groupcast transmission by the first UE based at least in part on at least one of the association between the sidelink resource and the groupcast transmission or an identifier associated with the first UE included in the negative acknowledgement.

23. The apparatus of claim 14, wherein the negative acknowledgement indicates the failed reception of the groupcast transmission by the first UE based at least in part on at least one of an identifier associated with the first UE included in the negative acknowledgement or a sequence number associated with the groupcast transmission included in the negative acknowledgement.

24. An apparatus for wireless communication at a base station, comprising:
a processor;
memory coupled with the processor; and
instructions stored in the memory and executable by the processor to cause the apparatus to:
transmit, to a group of user equipments (UEs) via a communication link, a groupcast transmission associated with the group of UEs;
transmit, via the communication link, a message indicating a sidelink feedback resource for a UE of the group of UEs to use in transmitting a sidelink feedback message comprising a negative acknowledgement that indicates failed reception of the groupcast transmission by the UE.

25. The apparatus of claim 24, wherein the instructions are further executable by the processor to cause the apparatus to:
receive, from the UE via the communication link, a feedback message comprising the negative acknowledgement that indicates the failed reception of the groupcast transmission by the UE.

26. The apparatus of claim 25, wherein the instructions are further executable by the processor to cause the apparatus to:
initiate a timer based at least in part on receiving the feedback message comprising the negative acknowledgement;
transmit, to the UE via the communication link, a retransmission of the groupcast transmission based at least in part on an expiration of the timer.

27. The apparatus of claim 25, wherein the instructions are further executable by the processor to cause the apparatus to:
receive, from the UE via the communication link, a second feedback message comprising a second negative acknowledgement that indicates the failed reception of the groupcast transmission by the UE; and
transmit, to the UE via the communication link, a retransmission of the groupcast transmission based at least in part on receiving the second feedback message.

28. The apparatus of claim 24, wherein the instructions are further executable by the processor to cause the apparatus to:
transmit, to the UE and a second UE of the group of UEs, a second message that indicates a sidelink resource for the second UE to use in transmitting a retransmission of the groupcast transmission to the UE.

29. The apparatus of claim 24, wherein the instructions are further executable by the processor to cause the apparatus to:
transmit, to the UE and a second UE of the group of UEs, a second message that indicates an association between the sidelink feedback resource and the groupcast transmission.

30. A method for wireless communication at a first user equipment (UE), comprising:
monitoring, from a base station via a communication link, for a groupcast transmission associated with a group of UEs comprising the first UE;
transmitting, to a second UE of the group of UEs and via a sidelink feedback resource, a feedback message comprising a negative acknowledgement that indicates a failed reception of the groupcast transmission by the first UE; and
monitoring, from the second UE via a sidelink resource, for a retransmission of the groupcast transmission based at least in part on transmitting the feedback message comprising the negative acknowledgement.
